(19) United States
(12) Patent Application Publication
(10) Pub. No.: US 2002/0019753 A1
(43) Pub. Date: Feb. 14, 2002

(54) System, method, and computer program product for assisting caregivers

(76) Inventor: John B. Boden, Lighrhouse Point, FL (US)

Correspondence Address: John M. Del Vecchio, Hodgson Russ LLP, One M&T Plaza, Suite 2000, Buffalo, NY, 14203-2391, US

(21) Appl. No.: 09/922,827

(22) Filed: Aug. 6, 2001

Related U.S. Application Data
(60) Provisional application No. 60/223,140, filed on Aug. 7, 2000.

(51) Int. Cl. G06F 17/60

(52) U.S. Cl. 705/3

(57) ABSTRACT

A computer program product, system, and methodology to provide for assisting a caregiver in caring for individuals. An electronic life ledger is maintained for each individual and has that individual's vital information data stored therein in a database. The life ledger comprises a plurality of web pages for inputting and editing the individual's medical history, budget information, physician information and so forth. The life ledger is accessible over a computer network making the individual's vital information data is available in an instant. A fee is charged to the caregiver for each electronic Life Ledger purchased.

### CROSS REFERENCE TO RELATED APPLICATION

Applicant hereby claims priority based on the Provisional Patent Application Ser. No. 60/223,140, filed Aug. 7, 2000, entitled “System and Method For Assisting Caregivers” which is incorporated herein by reference.

### BACKGROUND OF THE INVENTION

There exists an exploding growth of the percentage of the population requiring care (both physical and mental). Demographics point to the frail elderly as the largest segment of the population in need of care, such care comprising health and medical care, home care, basic necessities care, etc. This growth of individuals in need of quality care, combined with the separation of family units and the increasing complexity of caregiving issues, has left millions of family caregivers, healthcare providers, healthcare payers, and governmental agencies struggling to meet the demand. Present resources are fragmented, uncoordinated, scarce and strained. The demands placed on these caregivers must be met with efficient and cost effective systems to provide for the many faceted needs of those individuals requiring care, yet to date, no such system exists or is in place.

Presently, there is no systematic approach to ascertain what the needs of a particular individual are and what the particular individual's past medical history comprises. Oftentimes, an individual enters a hospital, nursing home, retirement home, etc, and the caregivers have little information pertaining to the individual to whom they are providing/administering care. Typically, the caregiver only has the information the individual provides when completing the admission papers. Even more unsettling is the fact that the individual is unable to accurately and fully complete such paperwork due to any of a number of reasons, such as a forgetful memory or simply not knowing or not being able to recall the information.

Against this sketchy backdrop, the caregiver steps in and attempts the daunting task of caring for an individual he or she know little about. Quite possibly the caregiver is not providing the best care to the individual because the caregiver may not even be in the position to develop a meaningful care plan. The individual receiving care is placed in a great disadvantage under the present system wherein as his or her care is or may become dependent on uninformed caregivers.

Past attempts to deal with the problems associated in providing care include several internet unsophisticated web sites that attempt to solve the problem. However, “ . . . the Web falls short in offering what elder-care specialists call ‘decision support’—interactive, step-by-step analysis of the family's needs and options”. (WSJ-7/19/00 p. B1).

Thus there is a present need for a system and methodology to provide a caregiver with the means to effectively and efficiently care for a one or more individuals. There is also a need for a system and methodology to provide the caregiver with the most accurate, relevant, complete, and up to date information pertaining to the individual receiving care. There is also a need to make the system easy to use so that a caregiver may obtain the necessary information without wasting time trying to find the information. To date, no satisfactory system exists.

### SUMMARY OF THE INVENTION

The invention provides a unique system, method, and computer program product for assisting caregivers in providing care for individuals. Caregivers provide care and/or supervision to individuals in need of care/assistance. Caregivers typically provide care for individuals comprising the elderly, children, the disabled, the chronically ill, and so forth.

The present invention solves the limitations and problems encountered in the past when a caregiver provided care for the elderly, sick, infants, incompetents, and so forth. This is accomplished by providing a system and methodology that utilizes computers in communication with one another over a computer network, such as the internet or world wide web. An embodiment of the invention presently bears the domain name “ElderIssues.com”.

An electronic Life Ledger is created for each individual receiving care. The Life Ledger is available to the caregiver over the computer network and provides instant access to a plurality of vital information data pertaining to the individual receiving care. The Life Ledger comprises a plurality of associated web pages for displaying the vital information data. The database comprises tables for storing and organizing the following categories of data: Emergency data, General data, Support People data, Medical data, Health Status data, Insurance data, Financial data, Budget Planner data, Legal data, Funeral Planning data, Documents data, and Physician(s) data. This data is then displayed on the caregiver's computer by way of a plurality of web pages, and may be edited at any time so that it is current and up to date. The Life Ledger database stores the vital information data accordingly, and makes all the vital information data available to the caregiver on demand and in an instant over the internet.

The system is secure in that only authorized caregivers have the requisite password to logon to the web site and access an individual's Life Ledger. A Life Ledger for each individual under the caregiver's care may be purchased by the caregiver by way of paying a fee to a merchant account maintained on the web application server computer.

The caregiver thus has instant access to the individual's Life Ledger comprising a plurality of vital information data. This instant access greatly increases the efficiency of the caregiver while simultaneously ensures that accurate information pertaining to the individual is used at every step of caring for the individual. This also allows the caregiver to care for a plurality of individuals as each individual has his or her own Life Ledger dedicated to storing that individual's vital information data. Additionally, this vital information data is available anywhere in the world in an instant so long as there is internet access. The present system and methodology is thus extremely efficient and reliable.

As described presently in the detailed description, the present computerized system solves the problems associated with past methods of caring for individuals and using wrong or obsolete information. The present invention also avoids paper and paper file storage systems and the problems associated with paper records, for example, the paper records may be archived and not available for several days or longer. There are no such problems with the computerized system of the present invention.

The following detailed description of the invention, when read in conjunction with the accompanying drawings, is in such full, clear, concise and exact terms as to enable any person skilled in the to which it pertains, or with which it is most nearly connected, to make and use the same.

### BRIEF DESCRIPTION OF THE DRAWINGS

FIG. 1 is a diagram of the of the system of the present invention.

FIG. 2 is a schematic diagram of the configuration of the system's database and data tables.

FIG. 3 is a flow chart illustrating the operation of the computer software program that generates the Life Ledger pages and associated Life Buoys.

FIGS. 4-18 show screen displays for the ElderIssues.com web site accessible and viewable from the web site's home page.

FIGS. 19-38 show the screen displays for the Life Ledger caused to be generated when the computer software program of the present invention is executed on the server computer.

FIGS. 39-40 show the screen displays for the forum and chat web pages respectively caused to be generated and displayed when the software program is executed on the server computer.

### DESCRIPTION

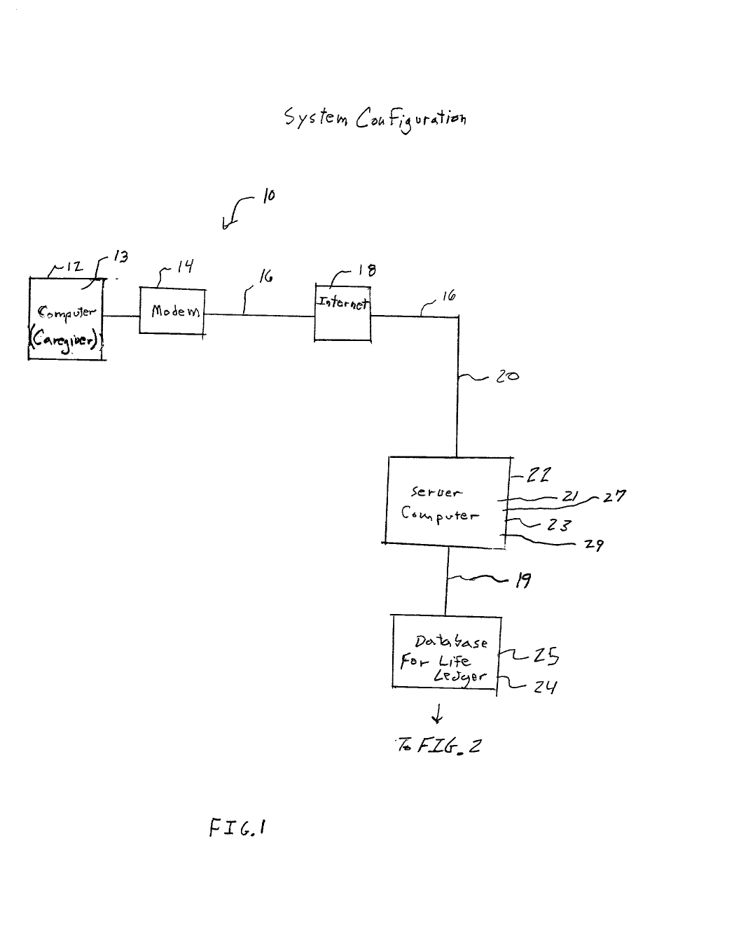

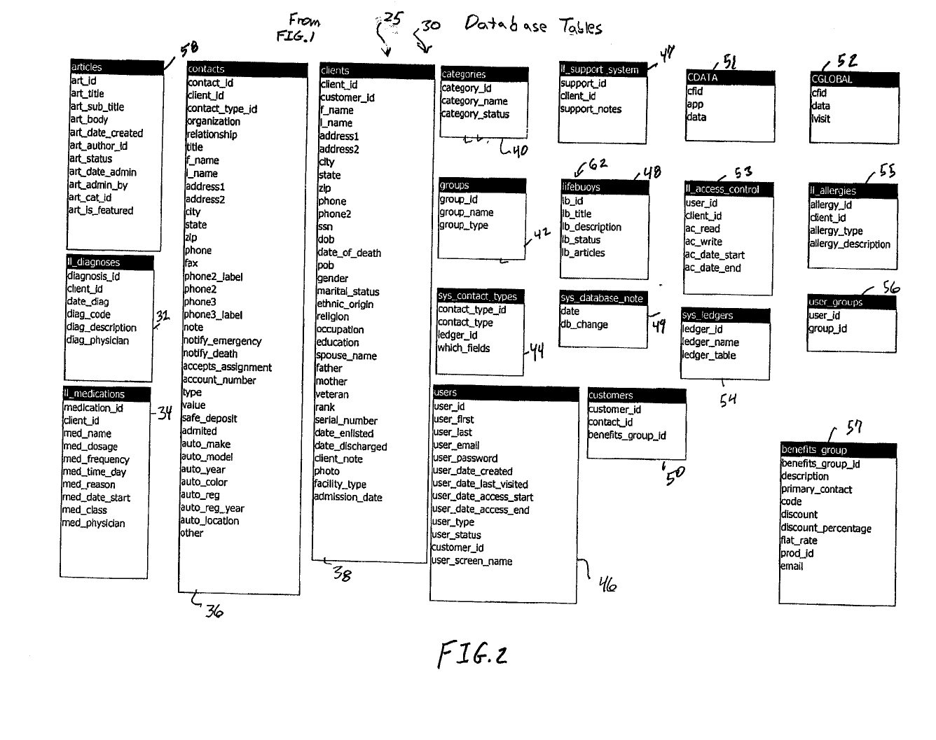

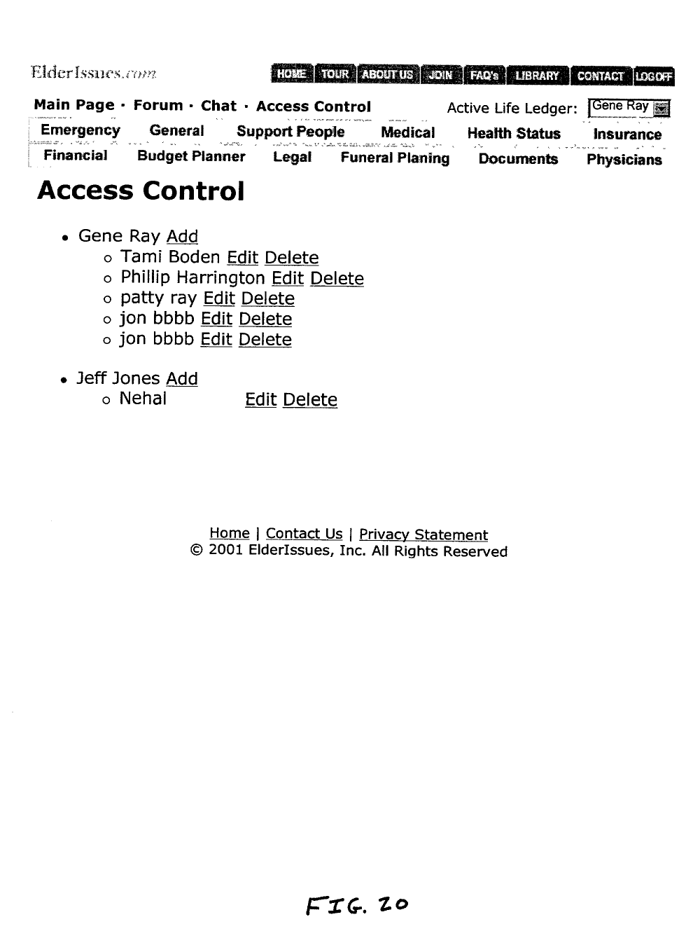

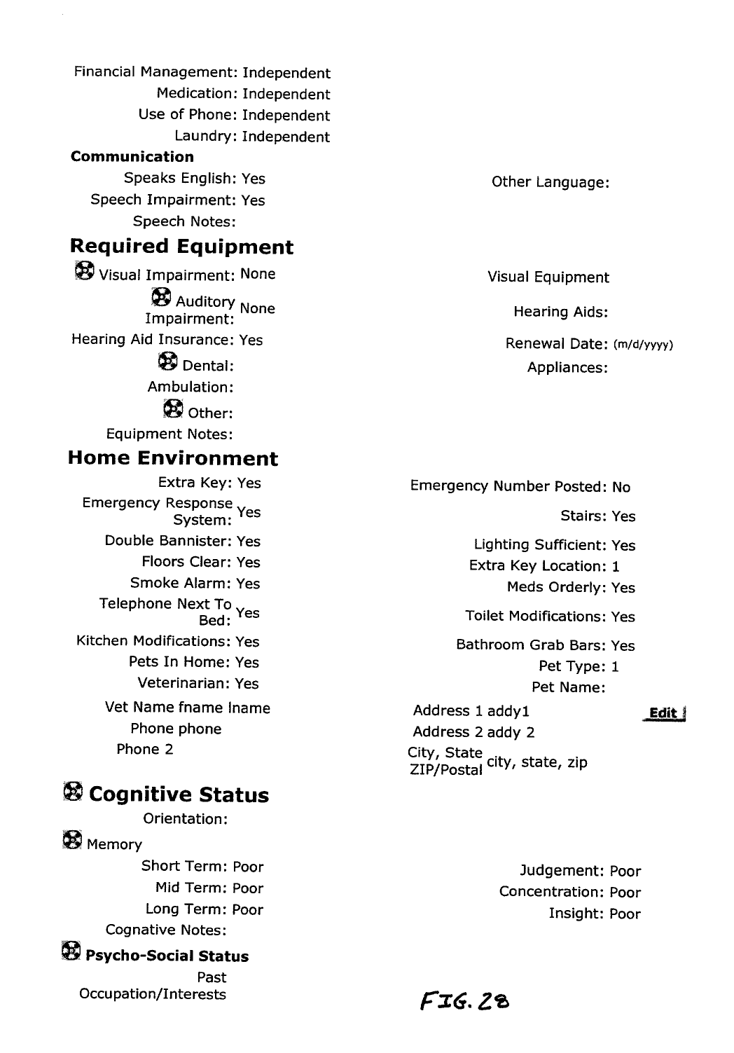

The present invention provides for a unique way for a caregiver (one who provides services, care, assistance to another, for example, a nurse, a doctor, a health care aid, a lawyer, a physician's aide, a nursing home, a person caring for a family member or friend, and so forth) to efficiently provide high quality care for an individual under care (hereinafter individual). The system 10 (FIGS. 1 and 2) and methodology, described presently, provide a new way for a caregiver to care for one or more individuals by creating and maintaining an electronic Life Ledger 24 (an example of an electronic Life Ledger 24 is seen in FIGS. 1-3, 19-38) for each individual receiving care. The Life Ledger 24 itself comprises a database 25 (FIG. 1) and stores in tables 30 (FIG. 2) plurality of vital information data pertaining to the individual receiving care. Vital information data is an expansive term and comprises emergency data, general data, support people data, medical data, health status data, insurance data, financial data, budget planner data, legal data, funeral planning data, documents data, and physician data (each of these is described in detail below). As described below, the Life Ledger comprises a separate web page for each of these aspects of vital information data.

Presently, the invention is embodied at a web site that presently bears the domain name “ElderIssues.com”. The caregiver may access an individual's Life Ledger 24 over a computer network 16 (FIG. 1) that may be embodied as the internet 18 or world wide web, by logging into the web site, and entering the requisite password from his or her own computer 12. A modem 14 may be employed to connect the caregiver's computer 12 to the internet 18. From there, a connection may be established to the server computer 22 as seen in FIG. 1. Such a configuration to gain access to the internet 18 known to those skilled in the art.

The system 10 is premised on an intuitive navigational system for ease of use, so that caregivers may move about the web site without excessive pointing and clicking with a mouse and without getting “lost”.

Membership Registration System

In order for a caregiver to access the web site and enjoy the advantages of using a Life Ledger 24 (FIGS. 1-3, 19-38) to care for an individual, the caregiver must purchase a membership using a credit card (or other acceptable form of payment). The invention may be embodied such that there are three types of memberships, corporation, corporate employee, and caregiver, with the rates for each type of membership being set by ElderIssues.com (monthly or yearly rates). An electronic merchant account is provided to manage this aspect of the invention, such merchant accounts known to those skilled in the art.

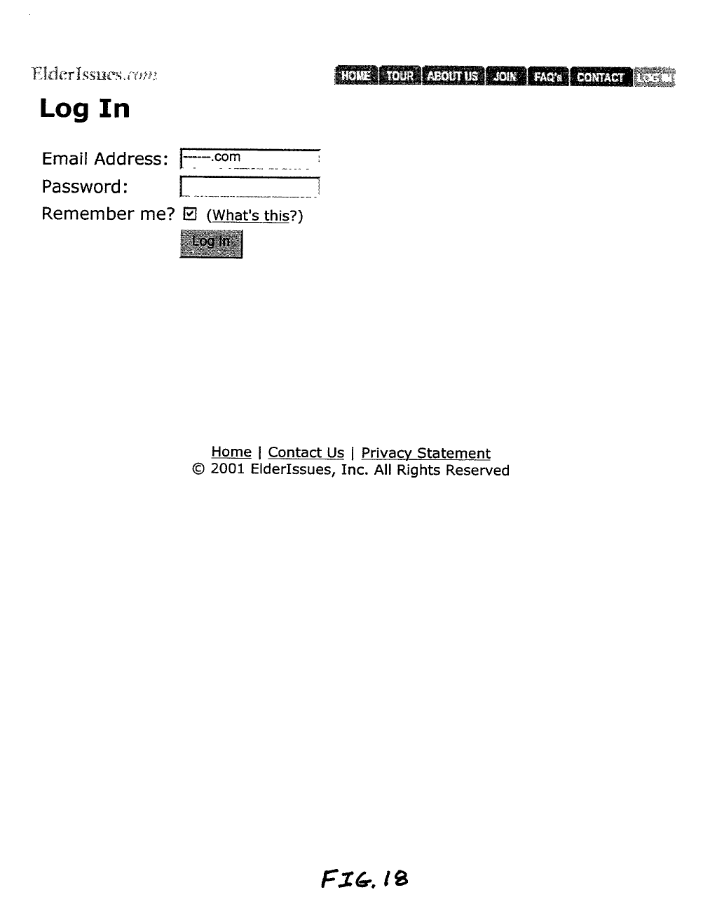

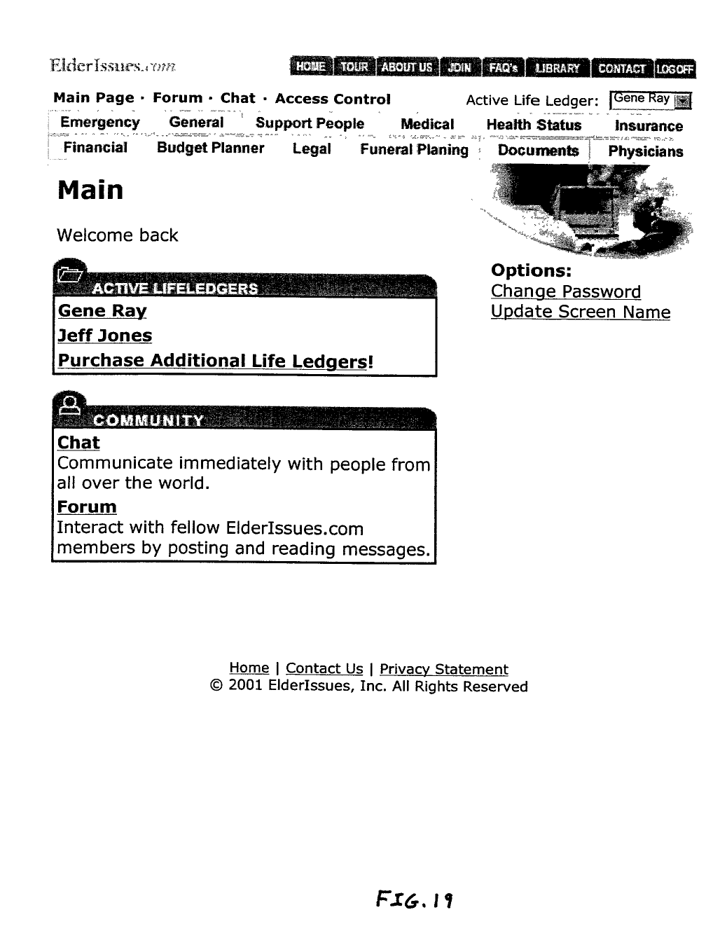

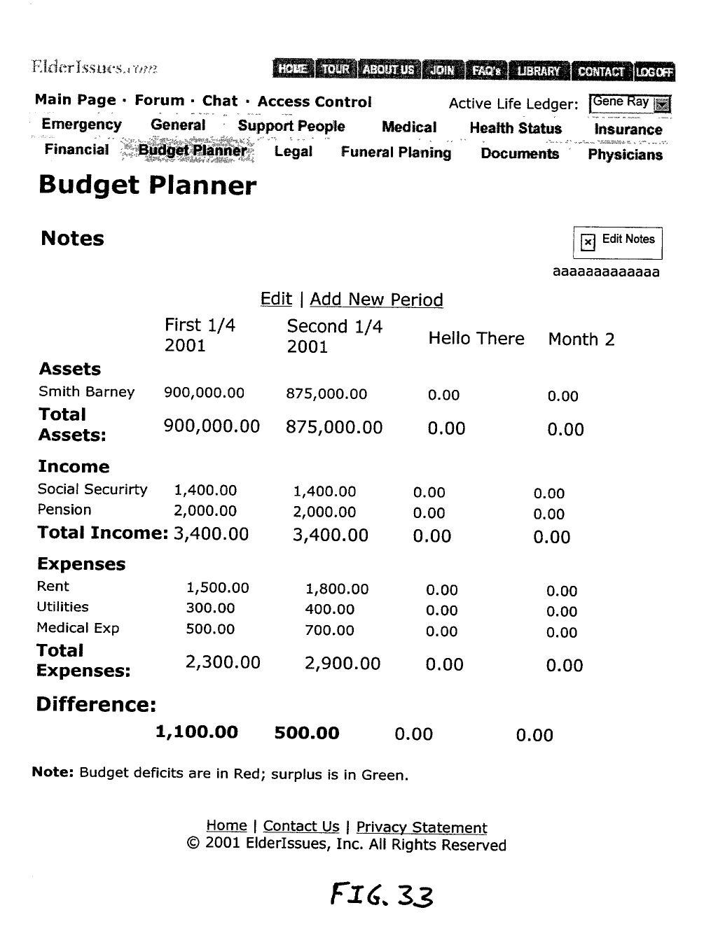

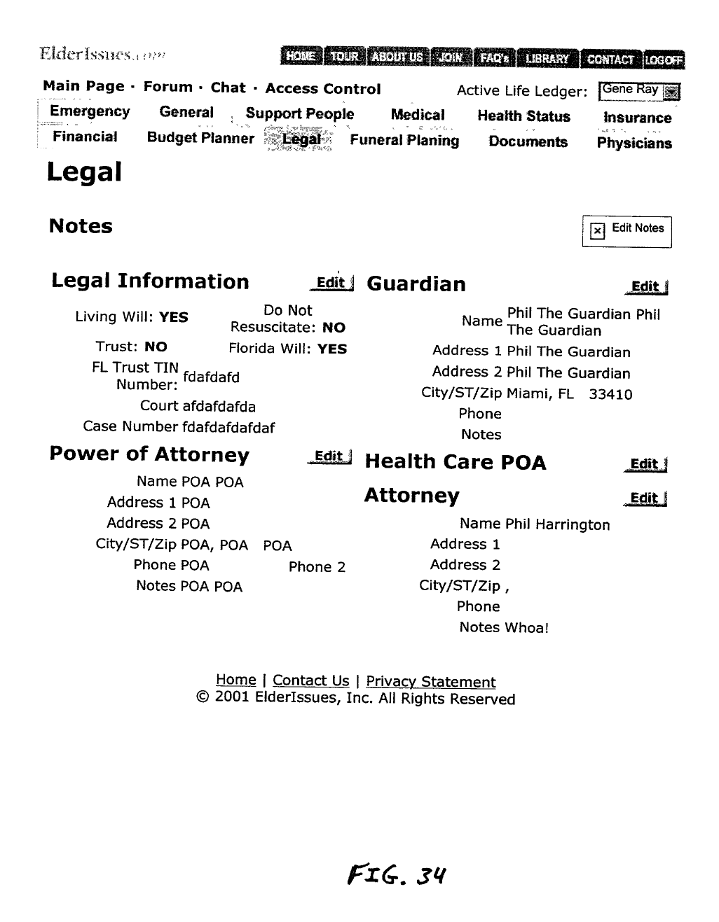

After registering, an email is sent to the caregiver over the internet 18 containing a temporary password for the caregiver to use. When the caregiver then logs into his or her account (the screen shot for logging in shown in FIG. 18) successfully, the caregiver's account will be activated. Once this is accomplished the caregiver may begin to fill out a Life Ledger 24 for an individual under his or her care by inputting vital information data into each of the web pages (FIGS. 19-38) of the Life Ledger 24 (in a manner described below). The caregiver may purchase and maintain additional Life Ledgers 24, for a fee, for additional individuals under his or her care. The system may be embodied so not all caregivers have full access to all the web pages of the Life Ledger 24. This means that access to certain portions of the Life Ledger 24 may be denied to some of the caregivers, for example, the primary caregiver or the individual himself or herself may not want the caregiver providing legal services (FIG. 34—typically a lawyer)to have access to the individual's budget planner data (FIG. 33).

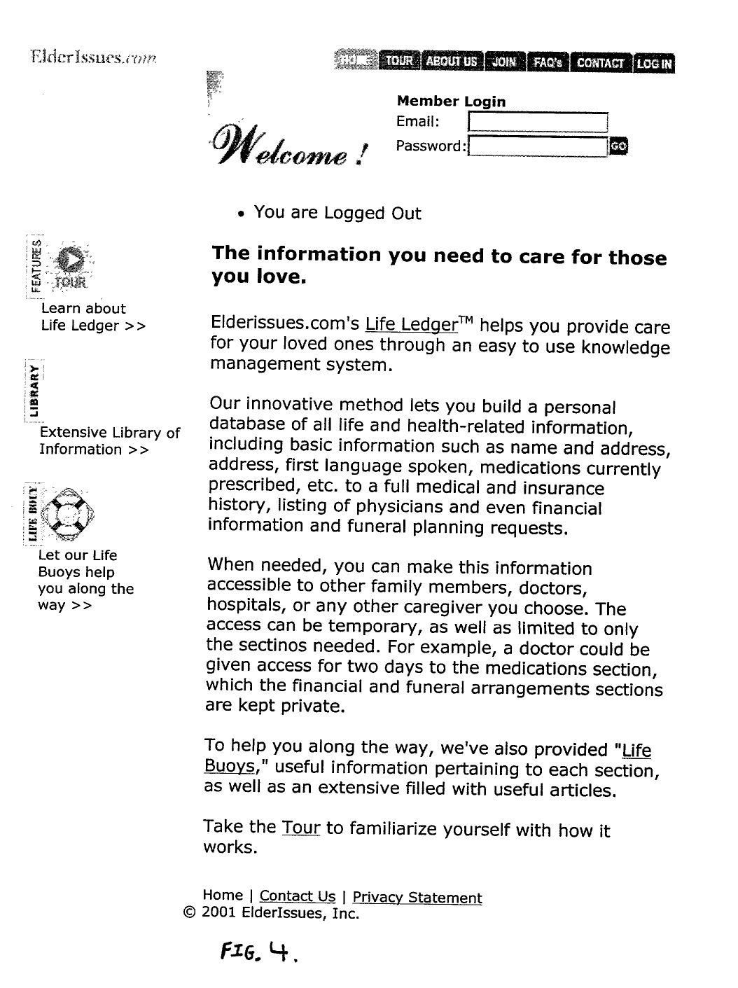

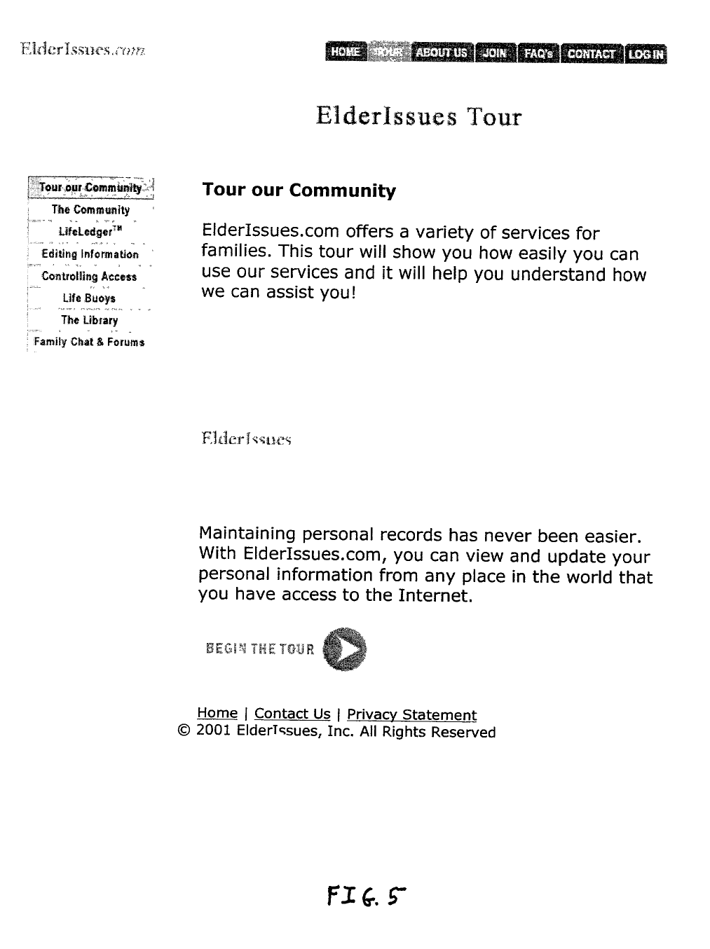

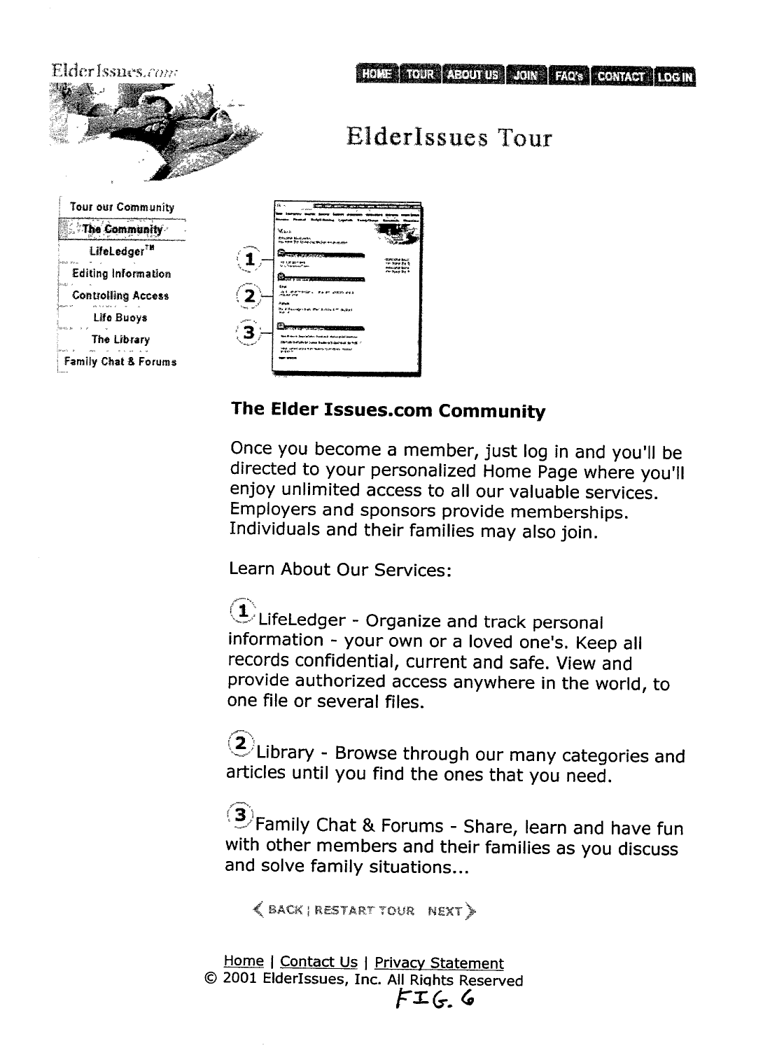

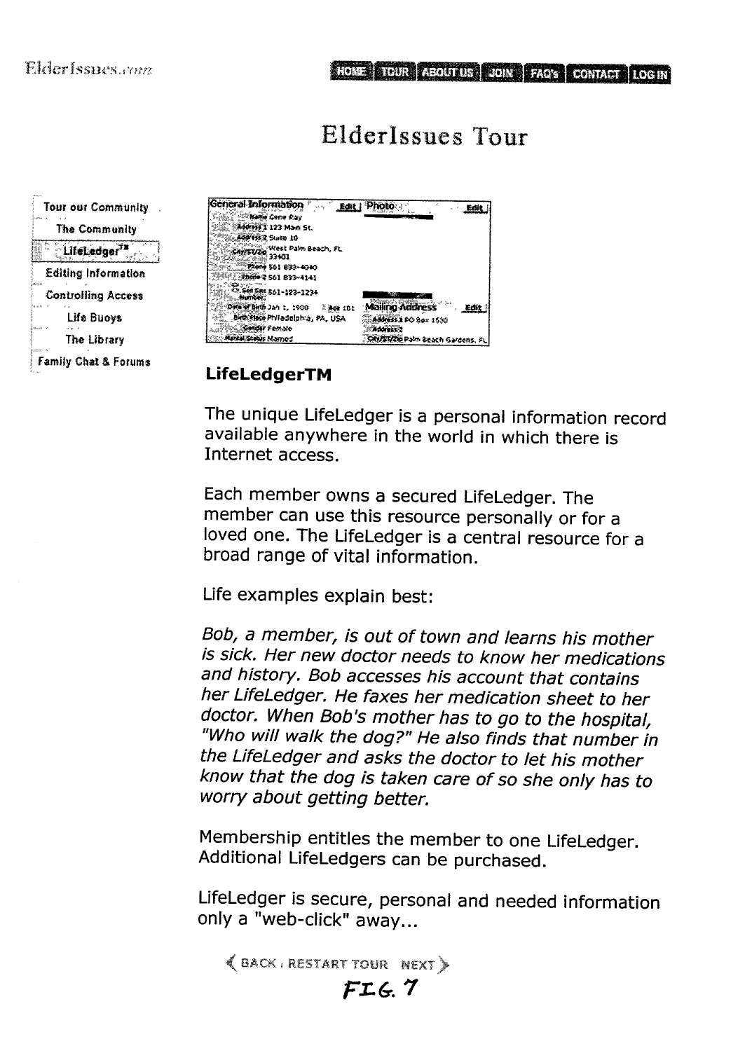

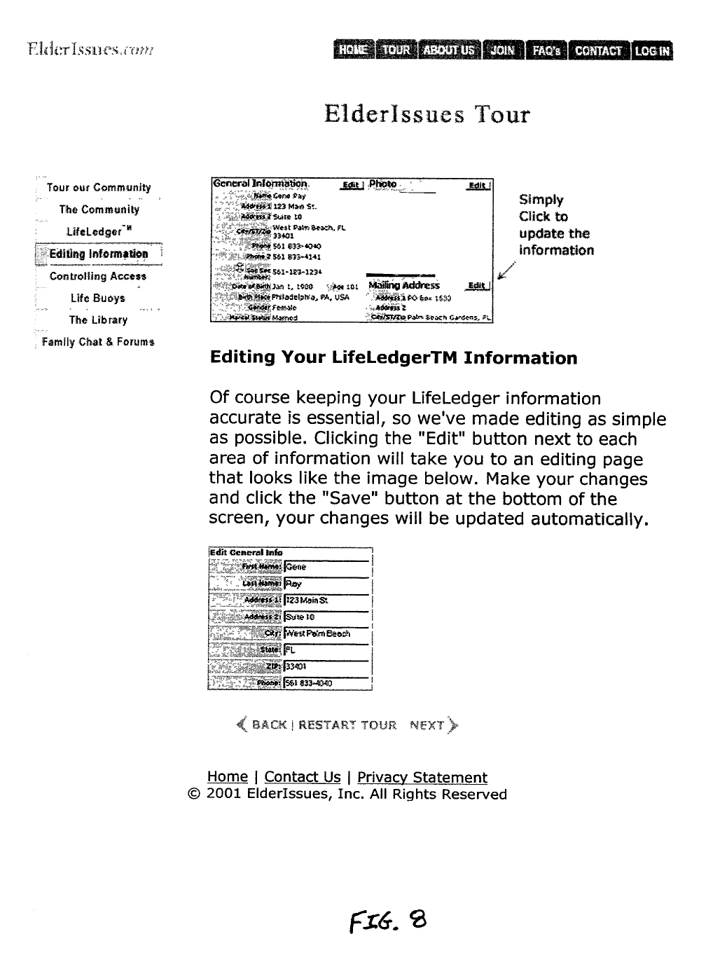

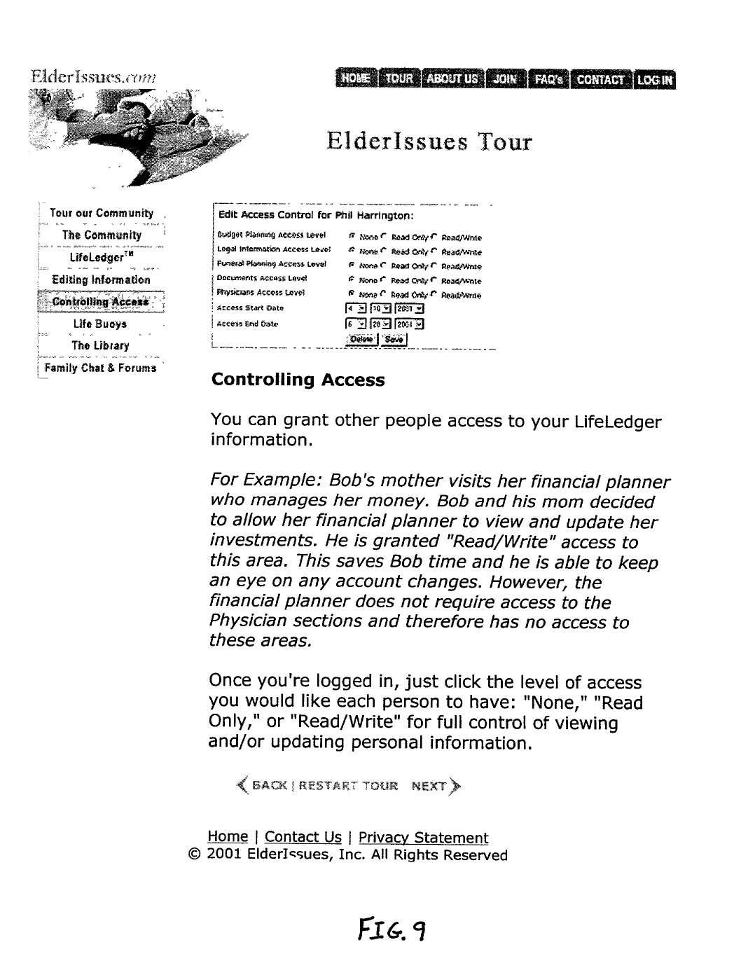

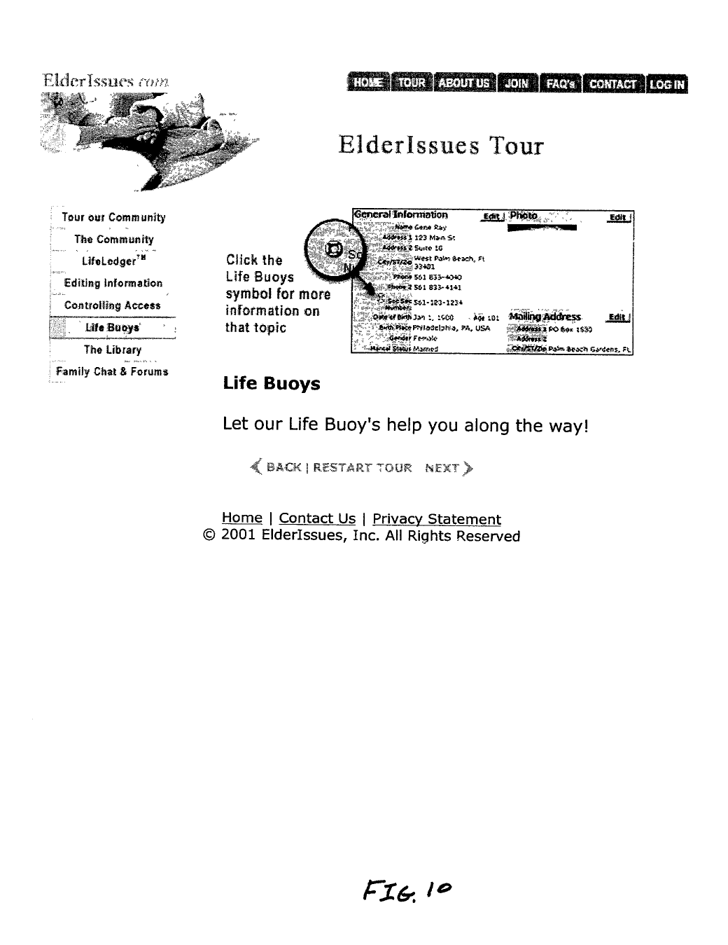

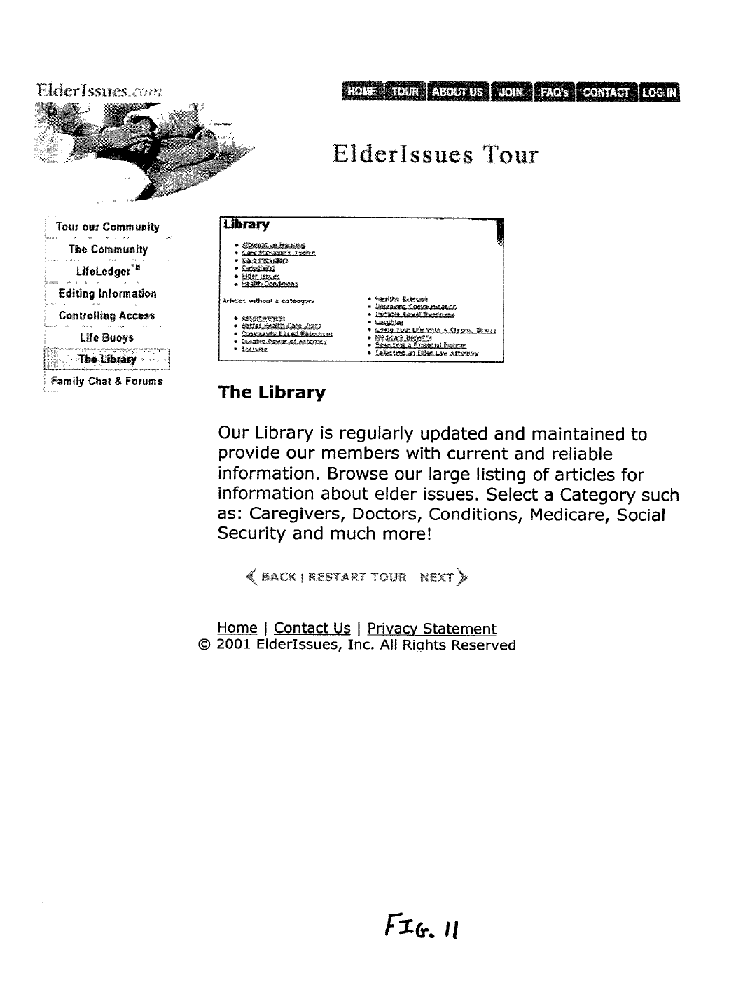

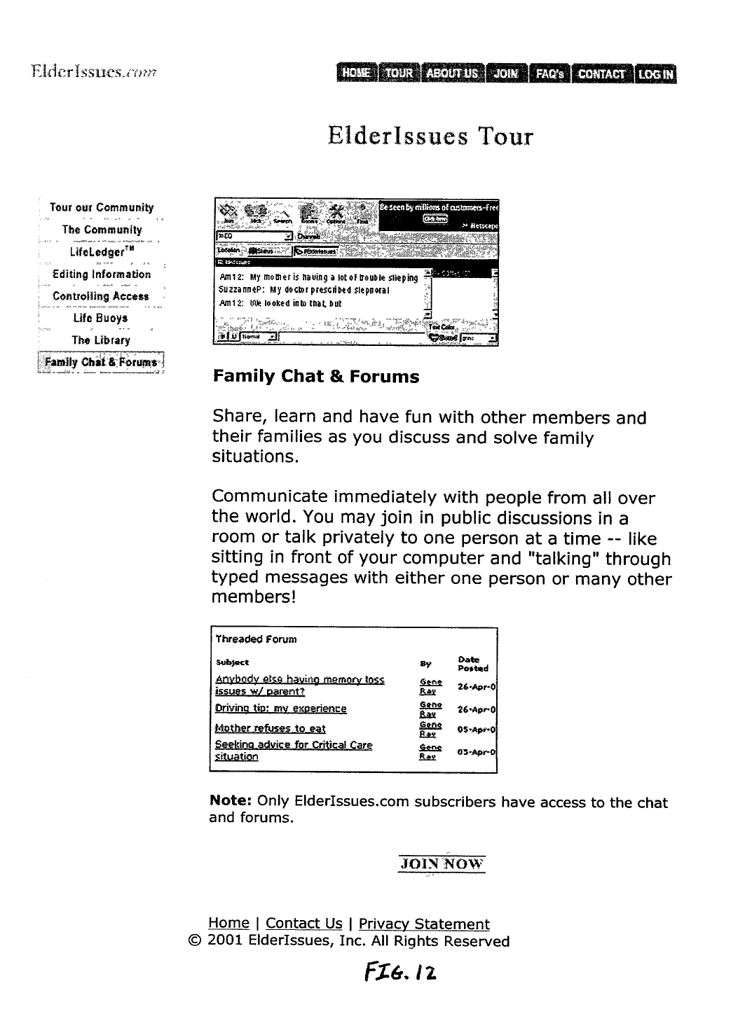

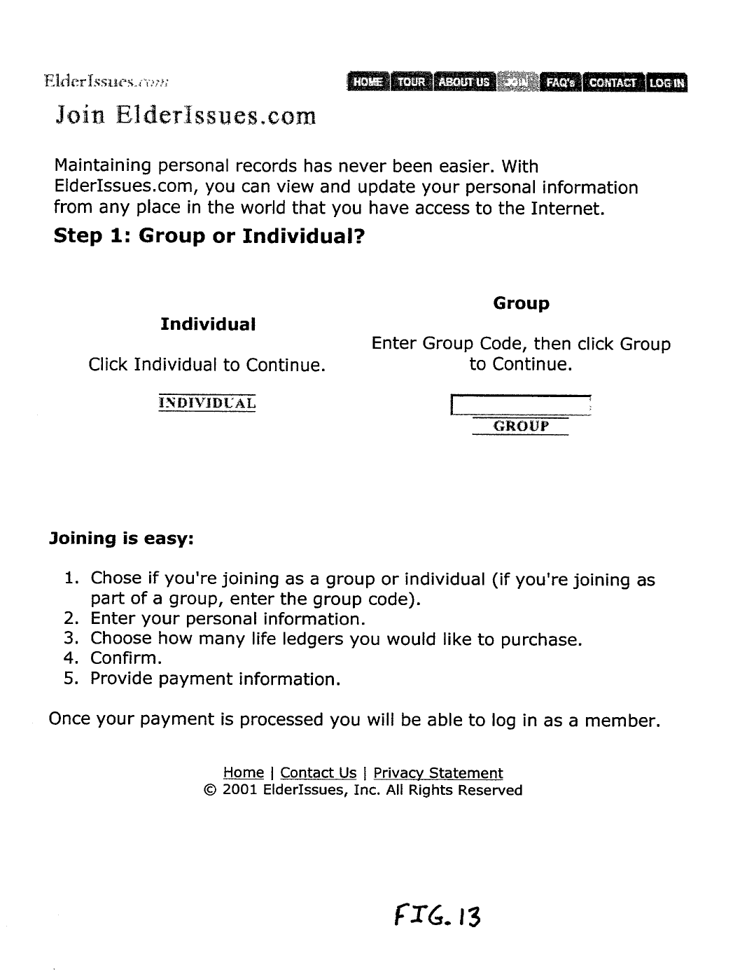

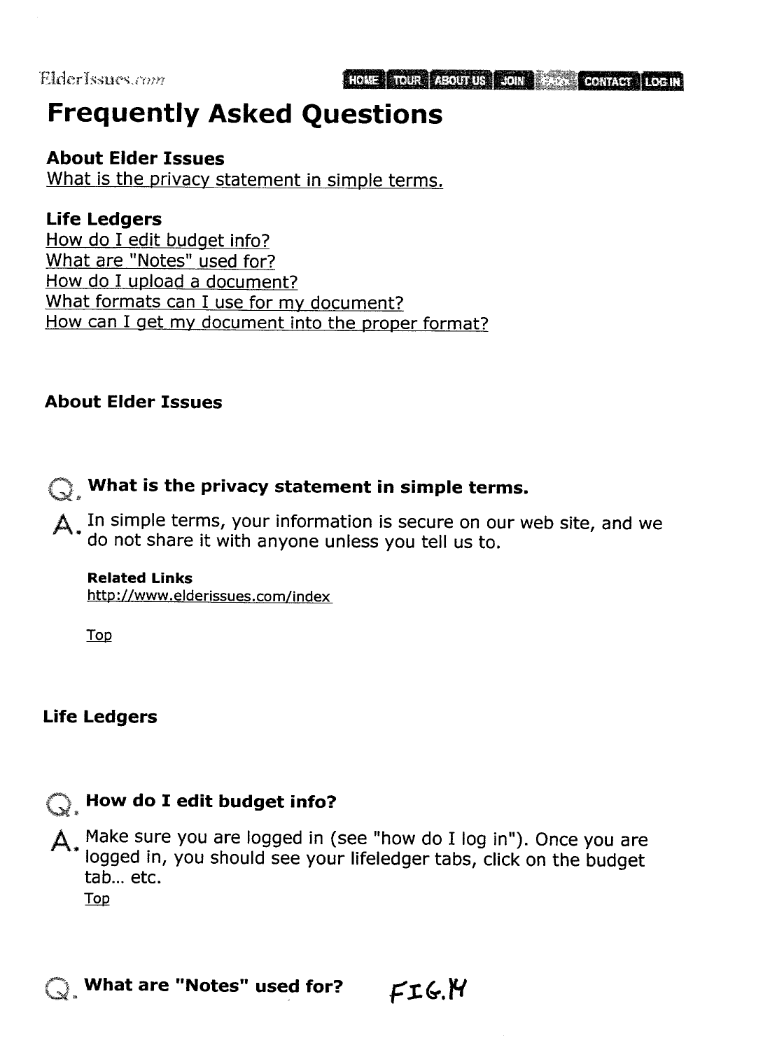

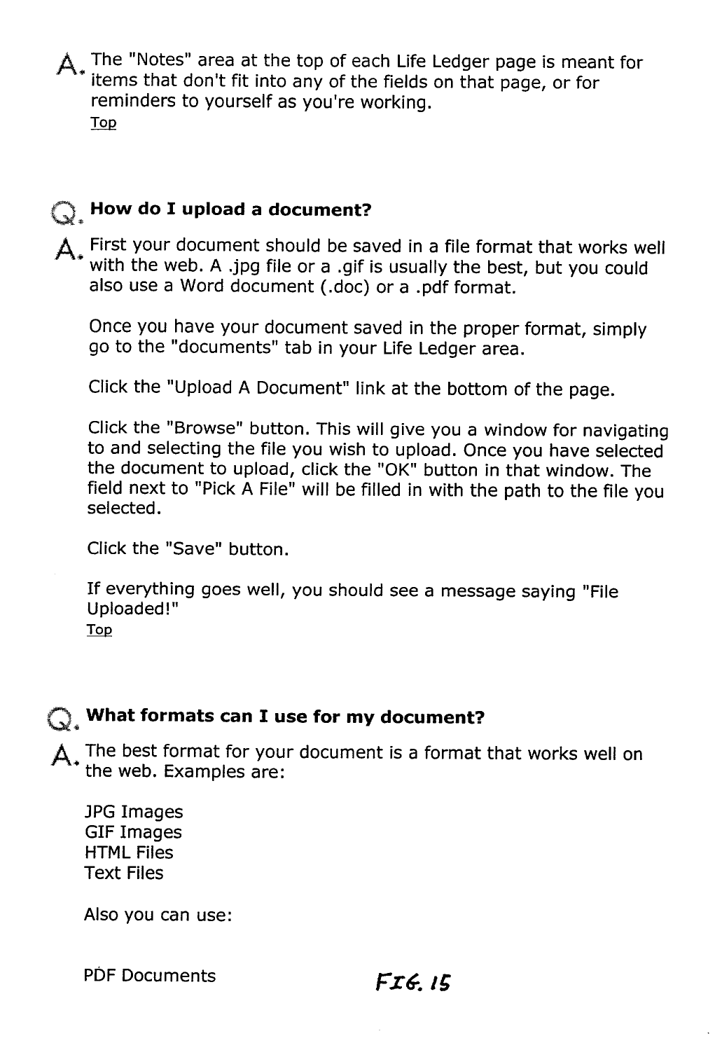

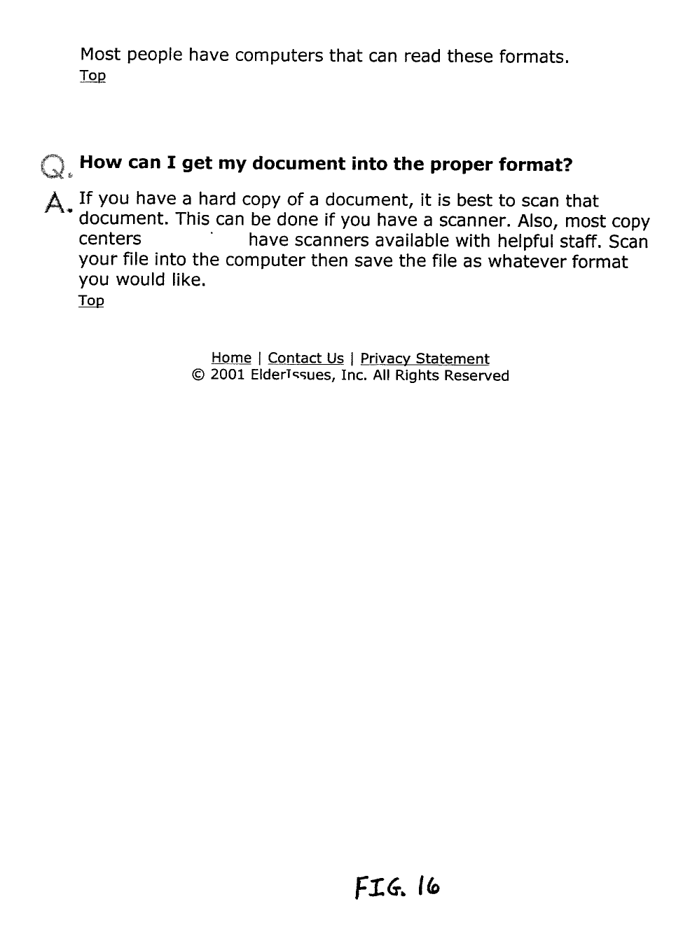

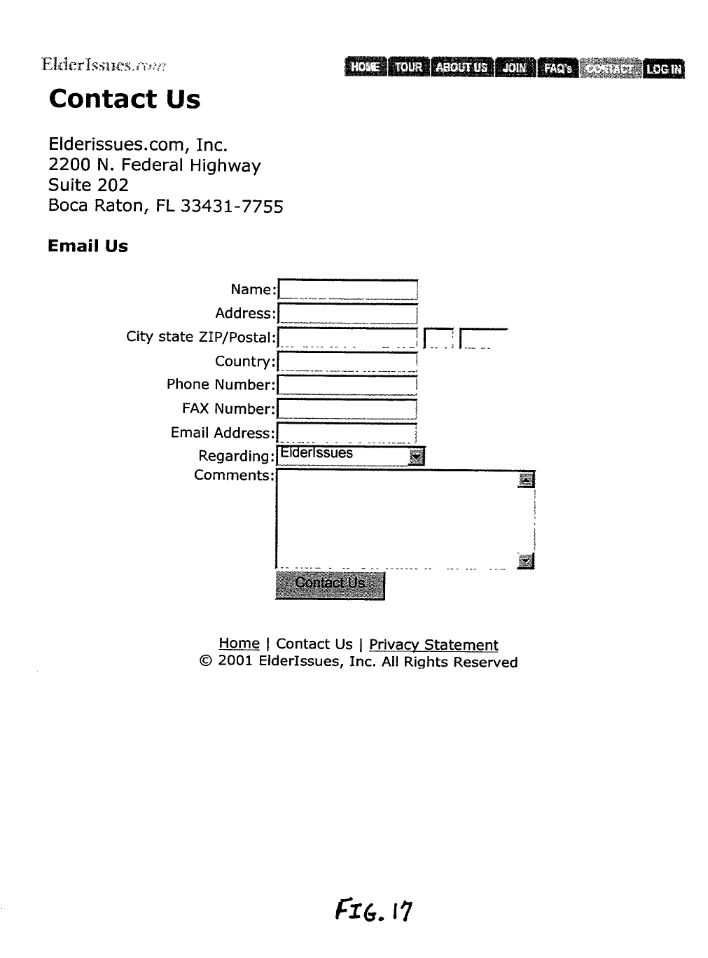

It is noted that prior to registering, the caregiver may take a tour of the ElderIssues.com web site (FIGS. 4-18). Briefly, the tour begins at the Home Page shown in FIG. 4, that Welcomes a caregiver upon accessing the ElderIssues.com web site. A plurality of tabs are arranged horizontally along the top of this web page, the tabs are labeled as follows: HOME (FIG. 4), TOUR (FIGS. 5-12), ABOUT US (company background information), JOIN (FIG. 13) FAQ's (FIGS. 14-16), CONTACT (17). The prospective caregiver may point and click on any of these self explanatory tabs and instantly pull up and review information pertaining to these web pages and learn about the ElderIssues.com web site.

Adding an Individual

When the caregiver takes on the responsibility for caring for additional individuals a new (blank) Life Ledger 24 needs to be purchased for the individual. The caregiver simply goes to the web site's merchant account 23 and buys the Life Ledger 24. Then, once the Life Ledger 24 is purchased, the caregiver proceeds to each of the web pages of the Life Ledger 24 (the web pages fully described below) and enters vital information data in the appropriate data input boxes on each web page. The caregiver can repeat this process again and again as more and more Life Ledgers 24 are purchased for the additional individuals under his or her care. The present invention therefore provides for a new business methodology and tool wherein Life Ledgers 24 are sold to caregivers over the internet for a fee.

Thus, the present invention is extremely useful when used in hospitals and institutions where a plurality of individuals are receiving care from the institution. In this situation the caregiver is the hospital/nursing home and many individuals have a hand in caring for the individual. The present invention provides a powerful tool such that one caregiver (nurse X for example) may leave the room or go off duty, and a different caregiver (nurse Y) may enter the room and immediately begin caring for the individual simply by referencing the Life Ledger 24 (FIGS. 19-38) and determining where the previous caregiver (nurse X) left off. The caregiver (nurse Y) may look at the vital information in the Life Ledger 24 and come to quick and correct conclusion on with respect to the next step of care, without wasting time paging through countless charts and unorganized sheets of papers or trying to locate or otherwise contact the prior caregiver (nurse X).

It is noted that the present invention may be embodied such that it can be utilized by a person who is not under another's care (the person is self sufficient) to keep track of his or her vital information data. Thus, in this respect the present invention is quite versatile.

Thus, caregivers can not only care for more individuals by using the invention described herein, but the quality of care for is much higher as the caregiver is dealing with current and accurate vital information data. This provides a substantial advantage of the present invention over prior art devices and methodologies. Another advantage of the present system and methodology is the mental relief given the individual under care in that the individual knows that he or she will not be asked the same questions again and again by different caregivers, nor will she or he have to remember all her or his vital information once it is entered into his or her Life Ledger 24.

Content Management System

The content management system may be embodied to comprise a structured query language database 25 (FIGS. 1 and 2) comprising all of the content (or the locations of the content that is not appropriate to store in the database 25 itself) for the Life Ledger 24 tables 30 (FIG. 2), and templates through which the tables in that database 25 can be managed.

A caregiver with the proper access authority can add data (a record) to a particular data 30 (FIG. 2), delete data from a particular data table 30, edit data from a particular data table 30, and view various reports online for the various tables 30 in the database 25. The caregiver may also view submitted data that is about to be approved for publication, and approve the submitted content causing it to become live content that can then be viewed through the content publishing system.

This content management system is accessible to any caregiver logged into the web site and having the requisite authority.

Content Publishing System

The content publishing system (CPS) causes the text and images to be displayed on the caregiver's screen 13 using a predetermined format. The content publishing system uses standard templates to format all the articles, graphics, and other submissions. For an additional fee, the caregiver can select and purchase various templates for the content. The content publishing system may also be embodied to provide a means for the caregiver to send out faxes, such means known to those skilled in the art.

The Life Ledger 24

It is noted at the outset that all of the vital information data input into the Life Ledger 24 (FIGS. 19-38) throughout this description is for illustrative purposes only.

Shown in FIG. 19 is a screen shot of the Main page for the Life Ledger 24. As seen in that figure, horizontal tabs are arranged across the top of the screen, each tab representing the vital information data that the caregiver has to complete for the Life Ledger 24. One of the purposes of the Life Ledger 24 is to collect/gather a great amount of vital information data pertaining to the individual in a logical, quick, and easy manner.

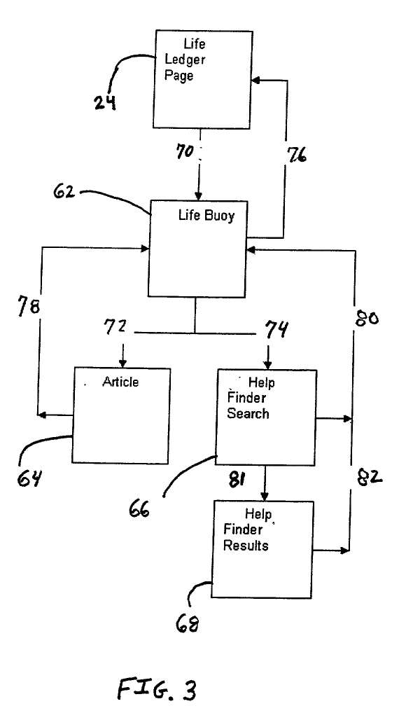

Each of the tabs when clicked on calls up the selected web page of the Life Ledger 24, each web page itself comprises data input boxes that needs to have vital information data inputted therein by the caregiver. The vital information data collected through the Life Ledger 24 forms are stored in the database 25 in appropriate data tables 30. Life Buoys 62 (FIG. 3) are accessed from the web pages and provide links to articles 64 and help 66, so that the caregiver may, for example, learn more precisely the vital information data that needs to be to be input into the data input box on a web page of the Life Ledger 24. The Life Buoy 62 feature is described in greater detail below.

Each individual has his or her own Life Ledger 24 that provides an in-depth profile of that person. The vital information data collected in the Life Ledger 24 is similar to a multi-page questionnaire wherein the vital information data is input, and can be subsequently saved, edited, or deleted. All the vital information data entered by the caregiver is validated by criteria provided by the caregiver, and the vital information data is then stored in the web site database 25 in the appropriate data table 30 on a page by page basis. This feature allows the caregiver to complete the Life Ledger 24 over a period of time or over a period of multiple sessions. This feature is also quite useful in the event new questionnaire sections (web pages) are added to the Life Ledger 24 over time.

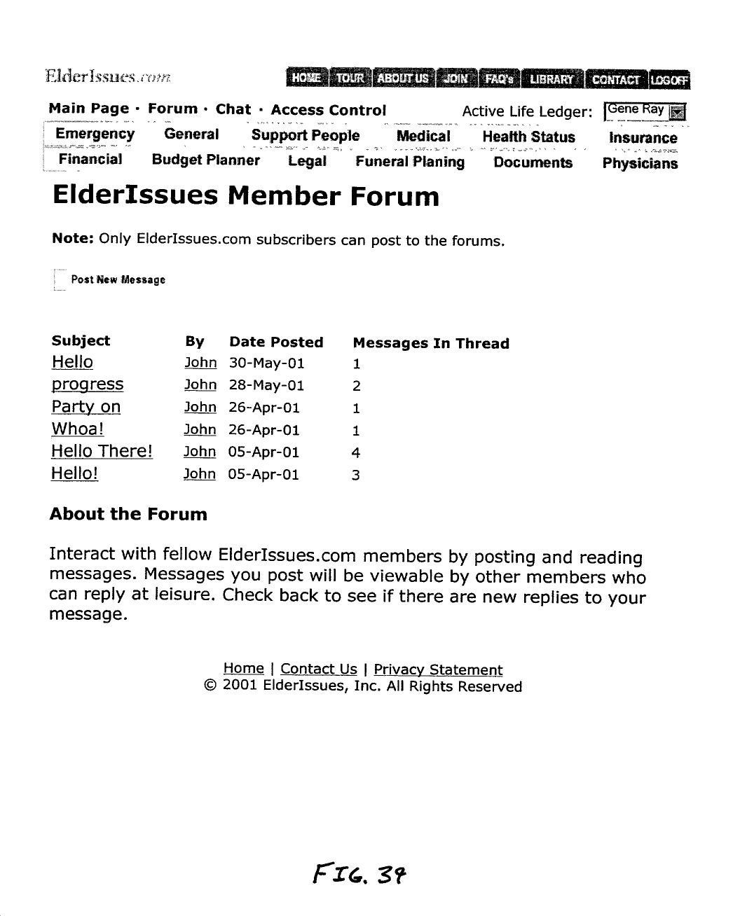

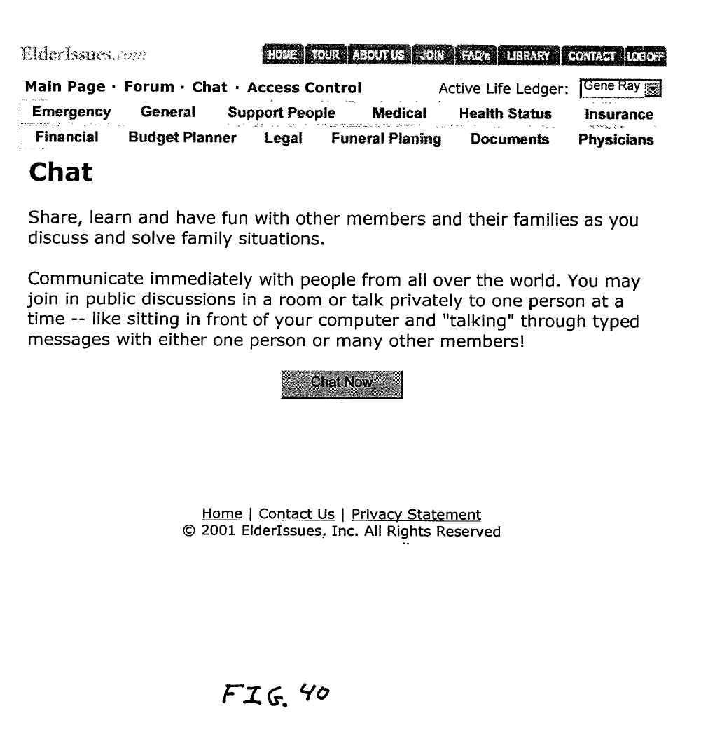

Also on the Main page (FIG. 19) is a pull down menu showing the names of all the individuals under the caregiver's care, this being under the ACTIVE LIFE Ledger 24S pull down menu. The caregiver may click on any of these individuals and be brought to that individual's Life Ledger 24. Also shown on the Main web page (FIG. 19) are ICONs that provide links to the Chat and Forum features (FIGS. 39-40) that allow communication between people from around the world and among the caregivers. These are described below.

FIG. 18 shows the screen shot for login into the ElderIssues.com web site where the caregiver enters a valid password to access the Life Ledger 24 feature.

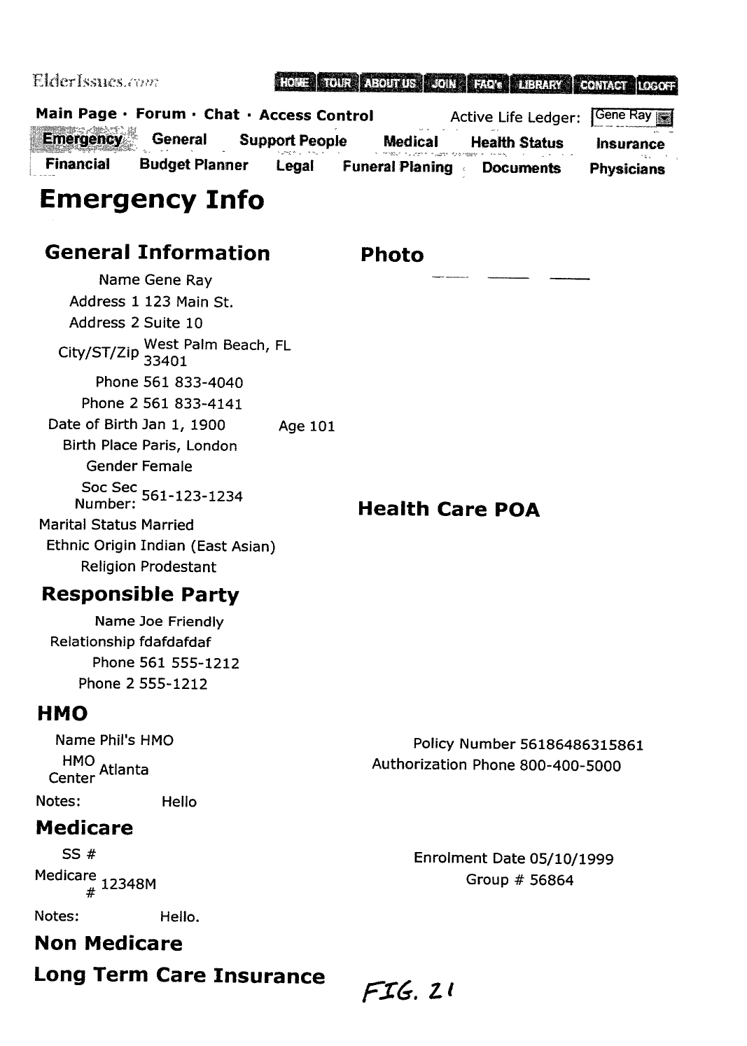

Turning now to FIGS. 21-38, the particular web pages of the Life Ledger 24 and the vital information data required to be input by the caregiver in each of the web pages is described. As described presently, each web page is dedicated to a different aspect of the individual's life. In particular, each web page keeps track of and maintains some aspect of the individual's vital information data. The database 25 comprises tables 30 for storing the Life Ledger 24 data. The Life Ledger 24 comprises a plurality of screen displays (web page(s)) (FIGS. 21-38) for inputting/deleting/editing vital information data pertaining to each of the following:

emergency data, general data, support people data,

medical data, health status data, insurance data,

financial data, budget planner data, legal data,

funeral planning data, documents data, and

physician data.

The database 25 stores and organizes the vital information data input for these web pages into a data tables 30 in the manner shown in FIG. 2. It is noted that for any of the input vital information data for each of these web pages may be edited at any time so that the data is current and accurate.

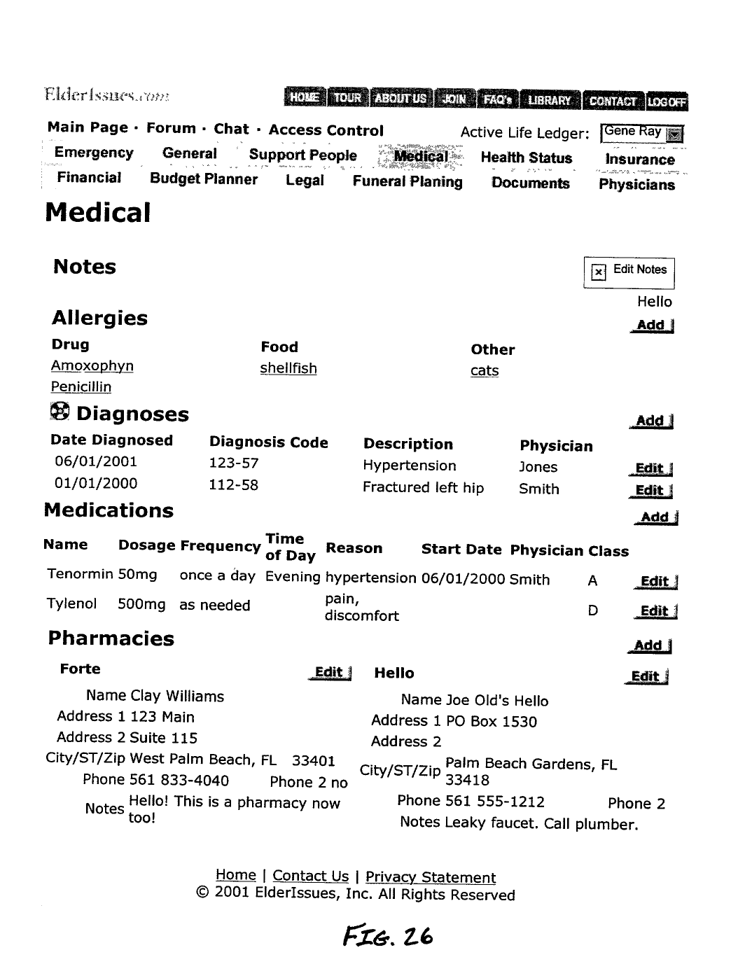

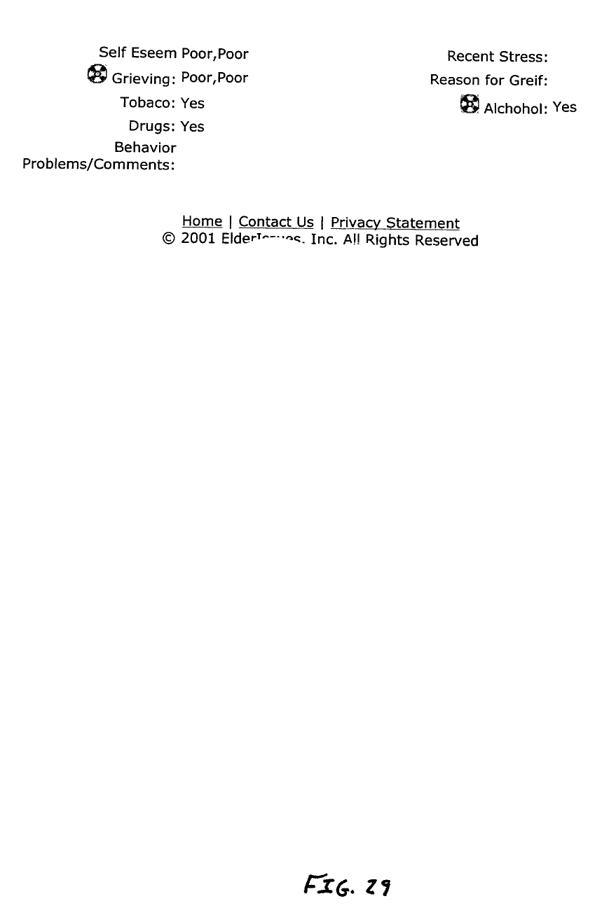

The caregiver controls access into specific areas of the Life Ledger 24, that is the specific web pages (FIGS. 19-38) of the Life Ledger 24, so that other caregivers they designate necessary for purposes of providing care have access to selected web pages of the Life Ledger 24. For example, an attorney may be provided with access to the Legal web page (FIG. 33), but not the Financial web page (FIG. 29) or Medical web page (FIG. 26). Again, this limited access to authorized caregivers is another advantage of the present system and methodology. Further, the system 10 may be embodied to give a particular caregiver limited access to certain web pages of the Life Ledger 24 for a defined time frame (e.g. one day or one week). For example, a selected caregiver may be given access to the Budget Planner web page (FIG. 33) of the Life Ledger 24 for a set amount of time. This expansive versatility of the system alone is an advantageous part of the invention.

What follows is a description of the web pages of the Life Ledger 24 and the vital information data stored in the associated data table 30 in the database 25.

Emergency Web Paces

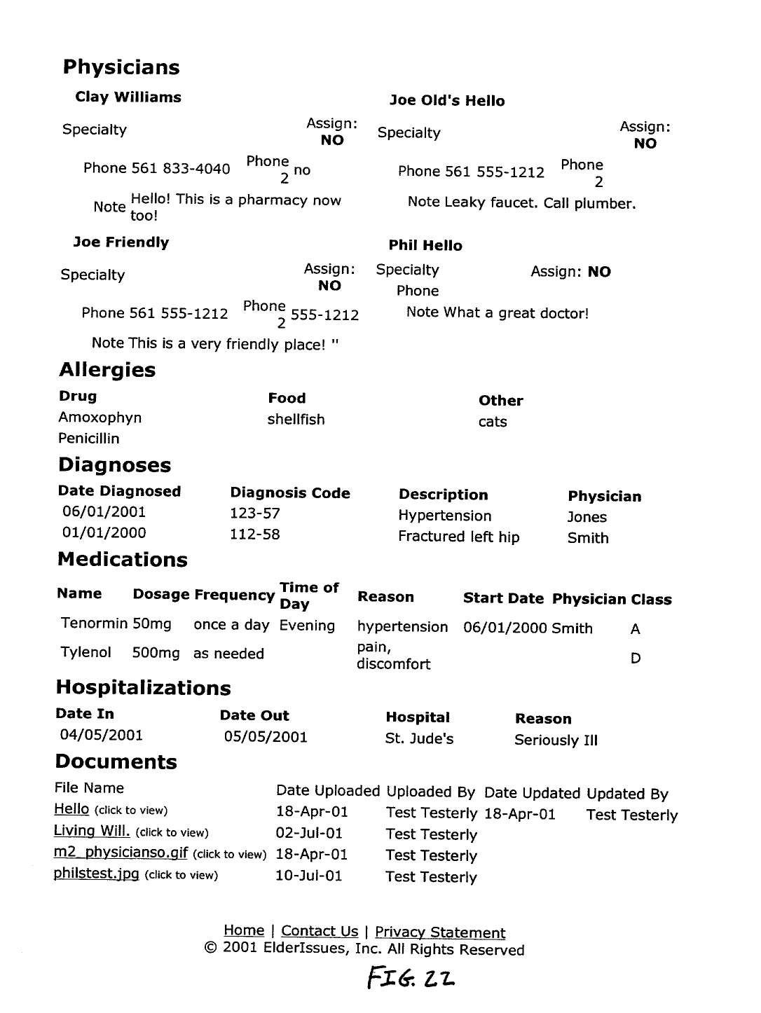

The Emergency web pages that are displayed on the client (caregiver) computer 12 graphical user interface 13 is shown in FIGS. 21-22. As seen in those screen shots, emergency data such as a photo of the individual, the individual's general information, name, address, responsible party, health maintenance organization, and so forth is entered and subsequently displayed. This allows a caregiver, in the event of an emergency, to have all relevant emergency information available for use in an instant.

The General Web Page

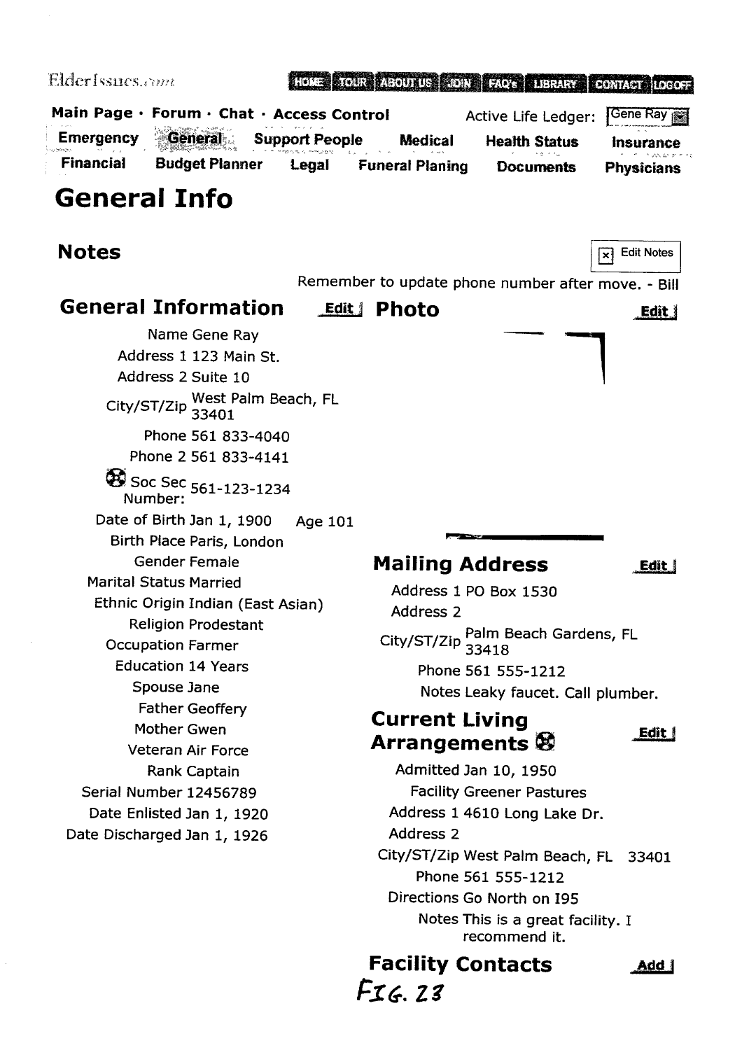

The General web page screen shot, seen in FIG. 23, provides for entry of a vast amount of general data about the individual, such as mailing address, date and place of birth, social security number, religion, military history, ethnic background, family, and so forth. A photo may also be included so that the likelihood the caregiver mistakenly identifies the individual is greatly decreased. This is an important and potentially life saving feature of the invention. Further, as with all the Life Ledger 24 web pages, any input information on the General page (FIG. 23) may be edited at any time by simply clicking on the edit button and editing, this allows for the updating of the individual's vital information data in substantially real time.

Support People Web Pages

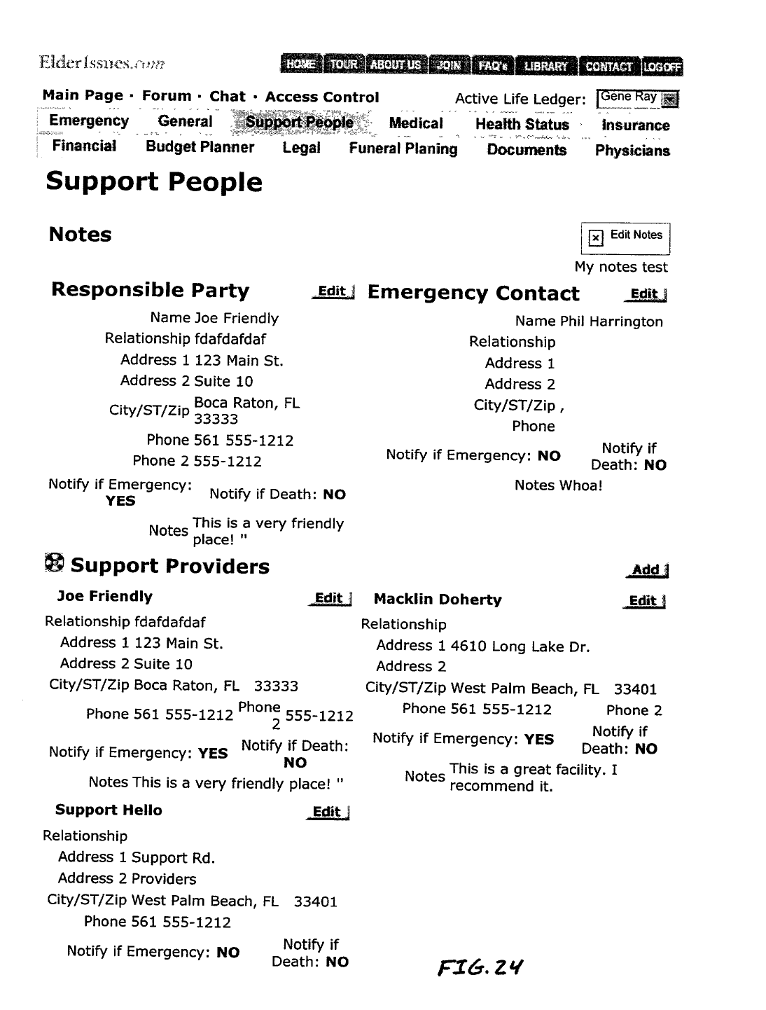

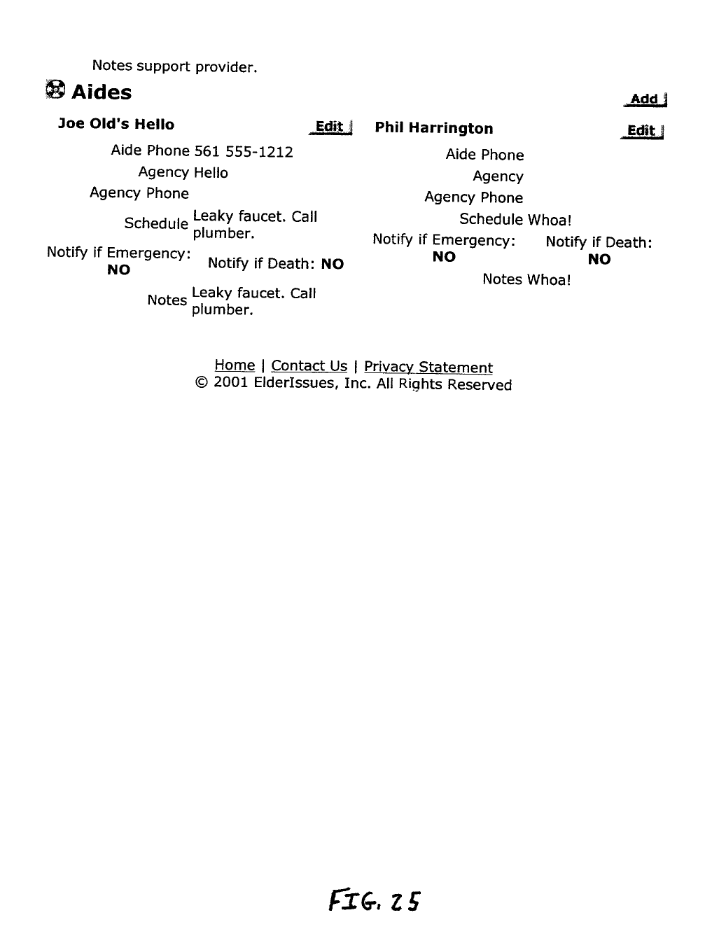

The Support People web pages are shown in FIGS. 24-25. This feature is for support people data, that is those people who play a role in providing care for the individual such as aides and friends. Again, the information contained on this web page may be edited by an authorized caregiver at any time to keep the information current.

Medical Information Web Page

The Medical Information web page screen display, seen FIG. 26, shows the medical data pertaining to the individual. Medical data such as medications, diagnosis, and pharmacies is displayed, and again, this data can be edited at any time by an authorized caregiver and the edited data stored in the appropriate table 30 in the database 25.

Health Status Web Pages

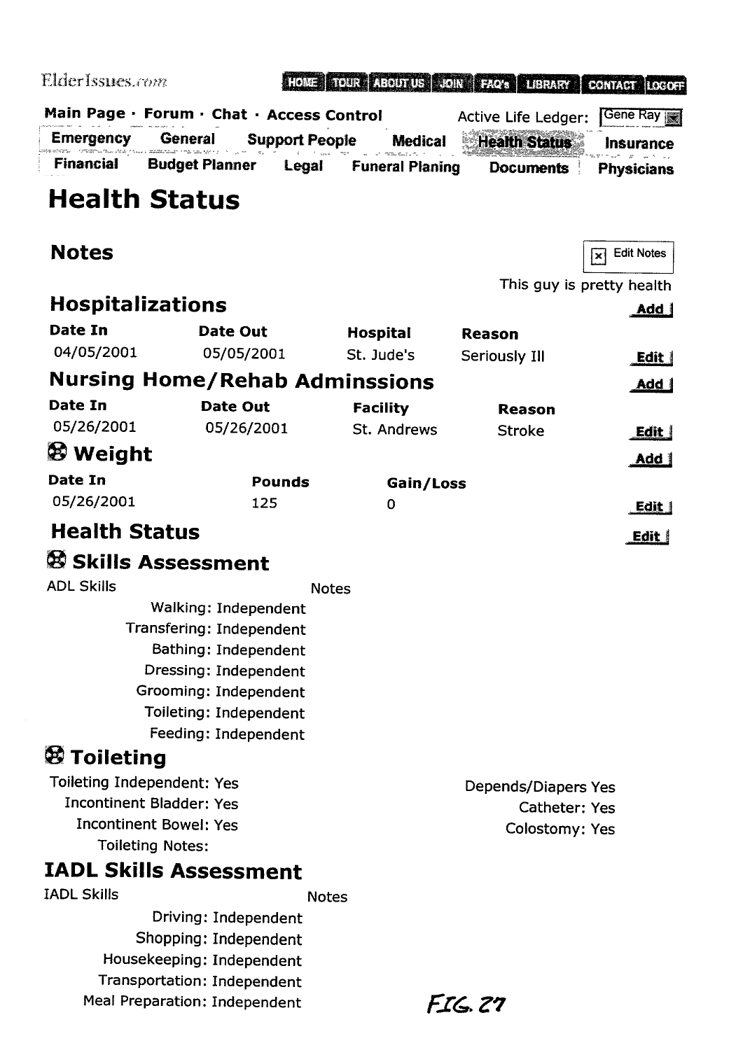

The Health Status web page, is for Health Status data, and is shown in FIGS. 27-29. As seen in those screen shots, the health status data to be input on this web page comprises hospitalizations, rehabilitation admissions, nursing home admissions, weight, health notes, skills assessment, toileting, driving skills, required equipment, home environment, and cognitive status. Further, once all of the data for the individual is input pertaining to these issues, a thorough and informative report of the individual's health is presented and preserved and accessible at some point in the future with the click of a button.

Insurance Web Paces

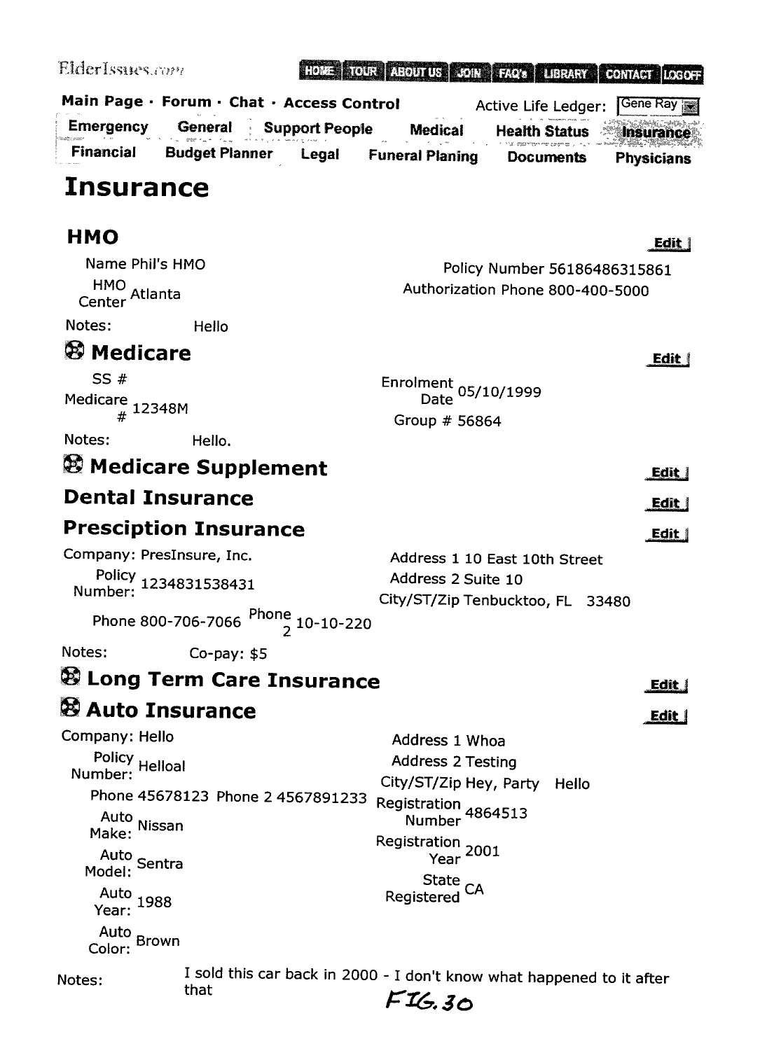

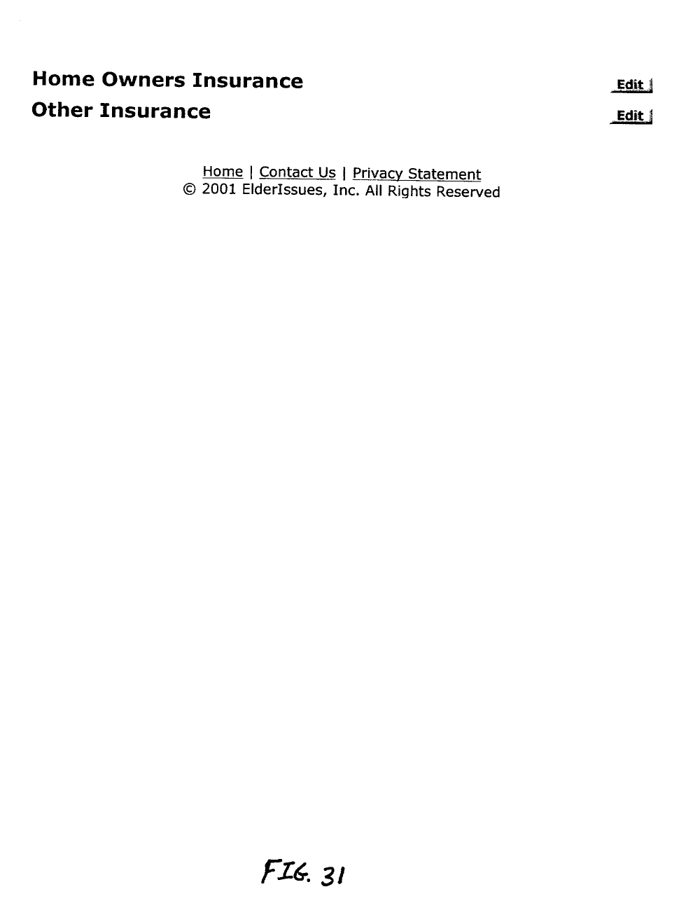

The Insurance web pages shown in FIGS. 30-31 are for recording and keeping insurance data pertaining to medicare insurance, medicare supplemental insurance, automobile insurance, HMO (health maintenance organization) insurance, dental insurance, long term care insurance, home owners insurance, and other insurances. The caregiver has the ability to edit the insurance data so that it is always current. Again, this is a time saving and powerful tool that allows for quicker admissions to hospitals, nursing homes, etc, as vast quantities of out of date or incorrect insurance information will not have to be sorted through to find the correct information.

Financial Web Page

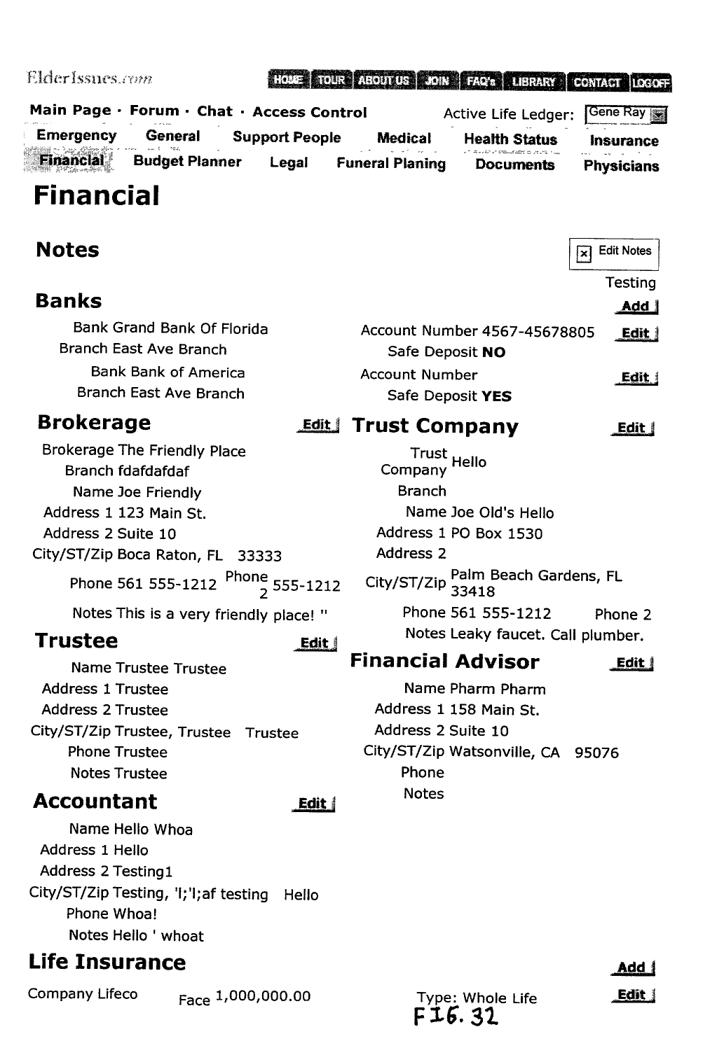

The next item on the toolbar provides access to the Financial web page (FIG. 32). The financial web page allows the caregiver to input financial data pertaining to the financials of the individual. As shown, bank, brokerage, trust company, trustee, financial advisor, accountant, and life insurance data may be input into the that web page. The financial data may be edited at any time so as to be accurate.

Budget Planner Web Page

The next item on the tool bar is for the Budget Planner (FIG. 33) web page. On this screen shot is displayed the individual's budget planner data that comprises the assets, income, and expenses, and any short fall of the individual. Again the budget planner data may be edited at any time in a manner substantially the same as previously described.

Legal Web Page

The next item displayed on the toolbar is for the Legal web page (FIG. 34). With a click of the mouse the caregiver is instantly brought to this web page. The legal web page is for storing and a later point in time displaying input legal data pertaining to, for example, power of attorney, guardians, and health care power of attorney issues. Again the caregiver may edit the legal data at any time.

Funeral Planning Web Page

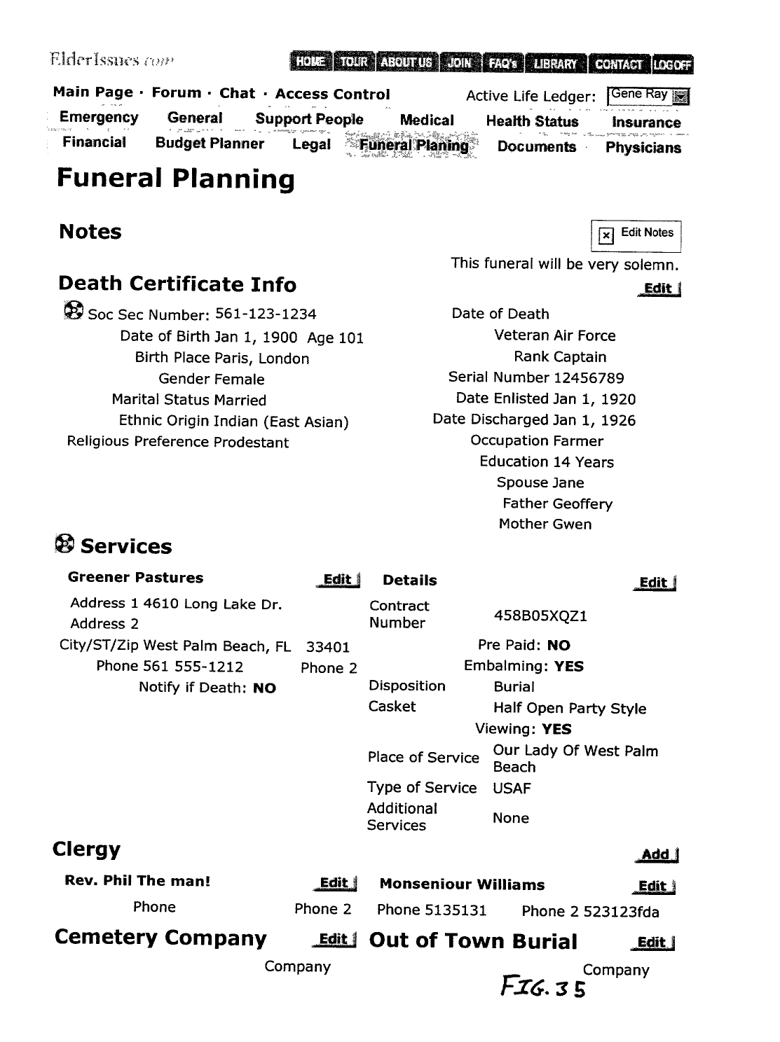

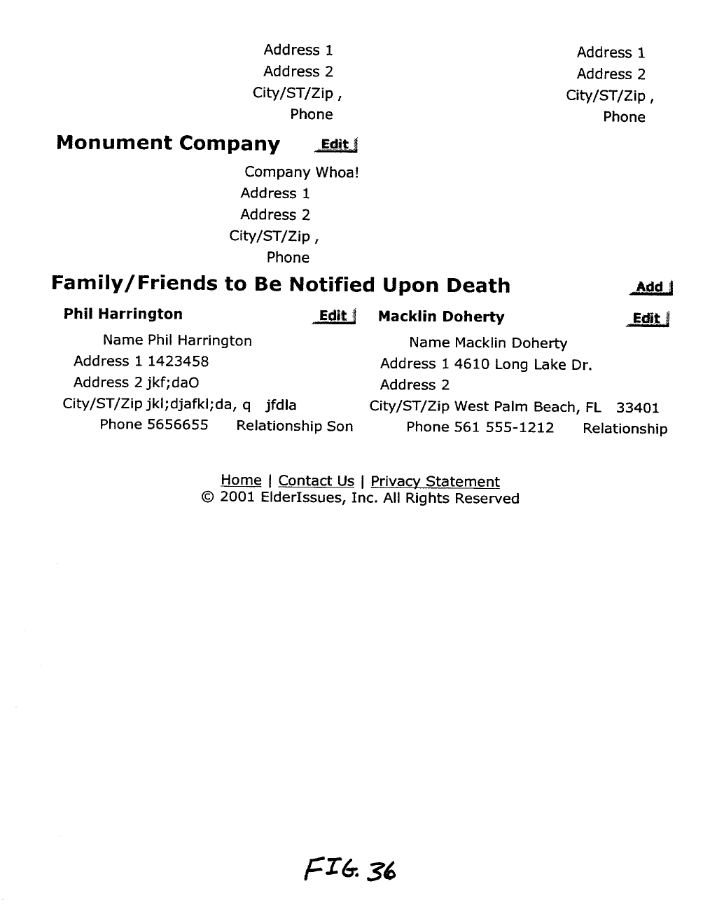

The next item on the tool bar (FIGS. 35-36) is for displaying the Funeral Planning web pages and associated information. Funeral planning data comprising death certificate, funeral service, clergy, cemetery, out of town burial, monument company, and family and friends to notify upon death are all aspects for which data is to be input by the caregiver, so that if and when the individual dies, the arrangements are in place. Again the caregiver may edit the funeral planing data previously entered.

Documents Web Page

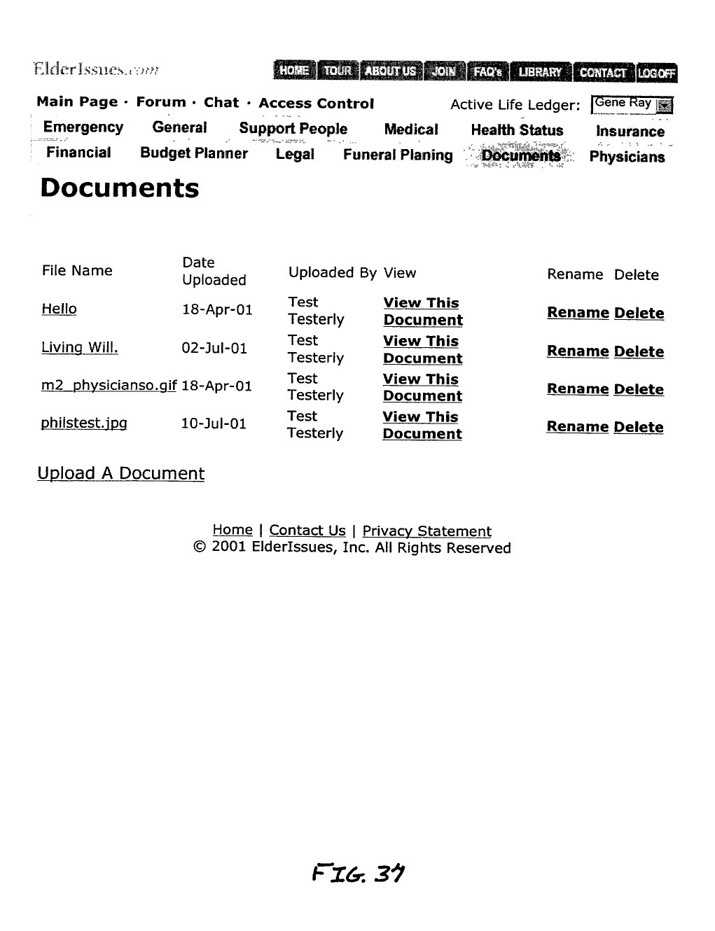

The next item on the tool bar is for the Documents (FIG. 37) web page. The caregiver may input document data comprising wills, living wills, and other relevant legal documents. Again, the document data may be edited at anytime by the caregiver.

Physicians Web Page

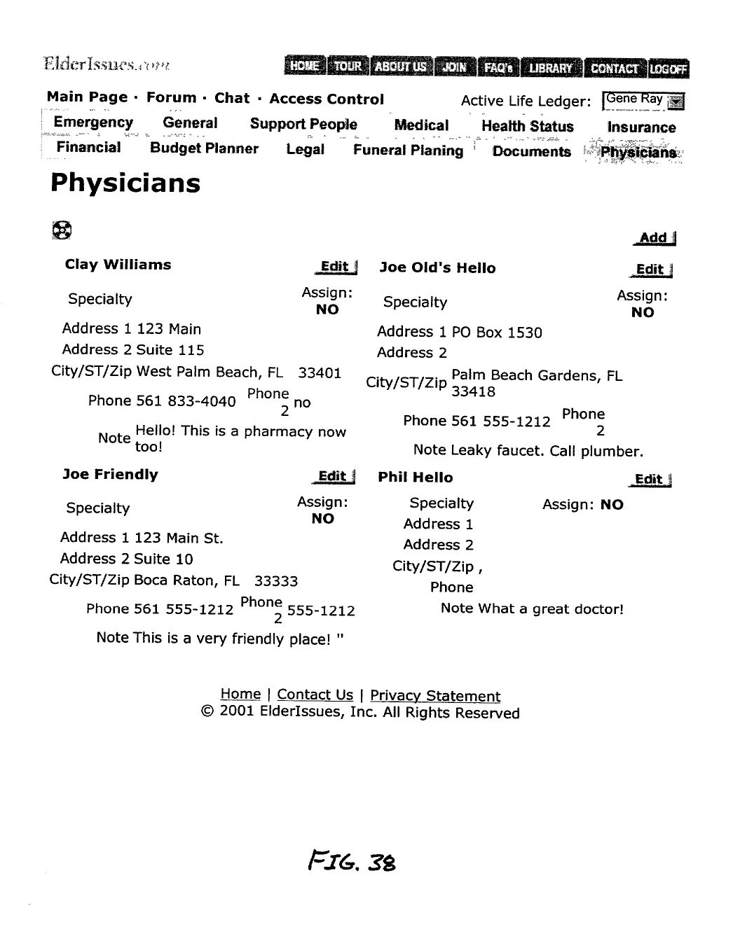

The last item on the horizontal tool bar is for the Physicians web page (FIG. 38). Physician data comprising the names and addresses of the individual's physicians accessed though this web page. The data displayed on the web page may be edited at any time by the caregiver.

The caregiver is thus able to efficiently and accurately make decisions pertaining to the individual's care based on an accurate up to date Life Ledger 24 and the vital information data stored therein. Thus the present invention provides for increased quality of care.

The Life Buoys

The present invention provides a unique feature/tool that greatly facilitates the ease with which a caregiver can use the Life Ledger 24 and make fact based decisions in the best interest of the individual under care. This feature is called the Life Buoy 62 (FIGS. 2 and 3), and appears numerous times on the various web pages described below and may be embodied to appear as small ICON, shaped like a Life Buoy on the web page. For example, in FIG. 24, Support Providers has a Life Buoy 62 displayed to its left. The content of the Life Buoy feature may be controlled by the web site administrator.

Certain vital information data to be input into the Life Ledger 24 sometimes requires further clarification or definition. Clicking on the Life Buoy 62, which is a link to pertinent information, redirects the caregiver to the pertinent information. The caregiver need only point and click on the Life Buoy 62 and instantly find out more information about a particular subject. Each Life Buoy 62 is strategically placed throughout the web pages of the Life Ledger 24 at points were a caregiver is likely to have questions about a topic, or about what particular vital information data needs to be input into a particular data input box.

As seen in FIG. 3, the Life Ledger 24 web page is linked by way of the topical life buoy link designated 70 to the Life Buoy 62 and then linked by topical link designated 72 to an article 64 in the database 25 that may directly answer the caregiver's question, in which case the caregiver is returned to the Life Ledger 24 web page from which he or she came by links 78 and 76 respectively.

The Life Buoy 62 may also be linked 74 to a help finder feature search 66 (FIG.3) feature that allows the caregiver to search for a particular topic and search for persons having knowledge and expertise on a particular issue. The help finder search feature 66 allows the caregiver to enter his or her zip code in order to refine the search.

The links 70, 76 refer to the Life Buoy 62 by an identification number. The identification number refers to the key field from the database 25 where the Life Buoy 62 data is stored. The link points to a page that retrieves information about the Life Buoy 62 from the database 25 using the identification number included in the uniform resource locator.

The configuration is such that the articles 64 that are mapped to the Life Buoy 62 are queried from the database 25. Links 72 to these articles 64 are presented in a list. The computerized system 10 automatically detects if a caregiver arrived at the Life Buoy 62 from a Life Ledger 24 web page. If so, a link back 76 to that Life Ledger 24 web page is offered, so that the caregiver can immediately return to the web page after the desired information has been obtained. Similarly, the individual article 64 pages can detect if the caregiver arrived at the page from a Life Buoy 62, and if so a link back 78 to the Life Buoy 62 is offered. Thus, there is little chance that a caregiver will become lost or otherwise disoriented in using the system, as he or she can always return to the point at which he or she started.

The present invention provides yet another advantageous feature. The Life Buoy 62 may be embodied so as to be linked to a Help Finder 66 (FIG. 3) searching tool to locate people having knowledge on particular topics. It is further noted that the Help Finder 66 page may be embodied to include the topic of the Life Buoy 62 so that this variable is included in the Help Finder 66 search page. The caregiver enters a search query topic and has the option of entering a zip code in a data input box on the web page. The advantage of this is that it will locate help within a geographic area when the search is conducted. The Help Finder 66 web page automatically detects which Life Buoy page the caregiver came from, and offers a link back 80 to that page. This helps to ensure the caregiver does not become disoriented or lost while using the Help Finder 74.

The Help Finder Search 66 is linked 81 to the to the Help Finder Results 68 that lists all the care providers from the database 25 that match the search parameters. The Help Finder Results page offers a link 82 back to the Life Buoy 62 from which the caregiver initially came. Hence the Life Buoy 62 provides useful information to the caregiver.

Chat and Forum

The Chat and Forum features, seen in the screen shots in FIGS. 39-40, allow for chat and a forum features that allows caregivers using the ElderIssues.com web site to communicate with people from around the world and one another, respectively.

It is noted that the present invention may be embodied in a plurality of embodiments, for example the above described horizontal toolbar may have additional web pages added to the Life Ledger 24. Such embodiments are intended to come within the scope and spirit of the present invention.

System and Program

The system 10 (FIG. 1) may be embodied such that it is carried out over the internet 18 (world wide web or other computerized network known to those skilled in the art). The system 10 comprises a client (caregiver) computer 12 in communication with a web application server computer 22 (server computer or web server computer) and a database 25 in communication with the server 22, such a connection may be embodied by way of an open database connectivity 19, connections of this type being known to those skilled in the art.

The means for communication between the computers may be embodied in a plurality of forms such as by way of modem 14, cable, or wireless technologies (carrier wave signals), all of which are known to those skilled in the art.

The server computer 22 executes a software program 21 that comprises a plurality of computer readable instructions on its central processing unit (CPU) 27. Those skilled in the art will recognize a compiler program may be employed to convert the software program 21 into machine language that the CPU 27 can recognize and execute accordingly. Use of a CPU 27 for reading and carrying out a software program 21 (computer coded instructions) is known to those skilled in the art. The computer program operates in accordance with FIGS. 1-3.

The computer software program 21 (application), when executed on the CPU 27, causes the plurality of data input web pages for the Life Ledger 24 to be generated. The computer program 21 is in communication with the database 25, the database 25 itself comprising a plurality of data tables 30 for accommodating the data in the Life Ledger 24 (FIG. 2). The data tables 30 are for storing and organizing the following vital information data when said data is entered by the caregiver: Emergency data, General data, Support People data, Medical data, Health Status data, Insurance data, Financial data, Budget Planner data, Legal data, Funeral Planning data, Documents data, and Physician(s) data.

The following is an example of how the computer program 21 allows for editing data in the database 25. FIGS. 21 and 22 show the Emergency web page of the Life Ledger 24 that is generated by computer software program 21 and caused to be displayed on the caregivers computer screen 13. Initially this web page is blank in that there are no vital information data inputs in any of the data entry boxes on the screen display (FIG. 34). This is because the table 30 in the database 25 for this web page is blank and has no data inputs therein. Thus, the caregiver initially sees the Emergency web page a screen with blank data input boxes.

The caregiver then selects one of the data input boxes on the Emergency web pages, for example the allergies data input box. The caregiver then inputs the appropriate vital information data, for example “Shellfish” is entered in the allergy data input box, and this is transmitted over the internet 18 to the server computer 22. The server computer 22 then sends this vital information data to the database 25 by way of online database connectivity 19, and the database 25 stores this input in the appropriate data table 30. Then the software program causes the screen display for the Emergency web page to display “Shellfish” as an allergy causing food product.

The caregiver may edit the vital data information pertaining to the allergies at any time by simply returning to the Emergency web page of the Life Ledger 24. Once there, the caregiver can view the previously entered data, that is the data that is stored in the data table 30 in the database 25 for the Emergency web page and click on the data to be edited. The entry “Shellfish” can be deleted, or additional allergy causing foods may be added and the new data is returned to the database 25 by the software program 21 over the internet. Thus the data in the data table 30 in the database 25 has been changed.

The web application server 22 provides for processing logic for the system 10 and is embodied so as to provide: access to the Life Ledger 24 and to the database 25, security to the system 10 by way of logon to system security 23 that authenticates users and controls access to resources (different web pages) by providing for encryption and passwords, and a merchant account 21 for recording monies paid and owed by caregivers and for automatic billing.

Turning now to FIG. 2, the database 25 for the system 10 is shown in detail. As seen in FIG. 2, the database 25 comprises a plurality of data tables 30 for storing the input data, or more particularly vital information data input into the Life Ledger 24 by the caregiver. The database 25 data tables 30 provide for the normalization of the vital information data so that data can be stored logically and efficiently in the database 25.

In FIG. 2 are shown the data tables 30 for: diagnosis 32, medications 34, contacts 36, clients 38, categories 40, groups 42, contact types 44, users 46, support system 47, lifebuoys 48, database notes 49, customers 50, Cdata and Cglobal 51, 52, access control 53, system ledgers 54, allergies 55, user groups 56, and benefits group 57. Each one of these tables 30 in the database 25 is for storing the data indicated by the above listed title for that table 30. One skilled in the art will readily recognize and understand the database 25 scheme as seen in FIG. 2. Further, FIG. 2 shows exactly where each piece of vital information data is stored in the database 25.

The items stored in the Life Buoy 62 (indicated by reference number 48 in FIG. 2) are provided with an identification number. The Life Buoy is connected to many articles 58 each of these having an identification number, and the computer program 21 finds the article 58 that has the same identification number as the item in the Life Buoy 62. In this manner the Life Buoy 62 retrieves articles 58 from the database 25 and makes them available to the caregiver.

In view of FIGS. 1-3, a computer programmer skilled in the art readily recognizes that a plurality of different software languages may be employed in conjunction with any of a plurality of different web application servers in order to carry out the present invention. For purposes of example, a product called ColdFusion available through Macromedia, Inc., 600 Townsend Street, San Francisco Calif. 94103 (www.macromedia.com) may be utilized in the present invention. By no means does the use of any particular product brand limit the versatility of the present invention, as those skilled in the art will readily recognize that the present invention may be employed and embodied via a plurality of different web servers and software languages made by any a plurality of different companies. Thus, those skilled in the art readily recognize that the present invention may be embodied in a plurality of different software languages being executed on suitable web application servers.

In use, the caregiver(s) logon to the ElderIssues.com web site server computer 22 from his or her client computer 12 and inputs an appropriate (valid) password. The caregiver clicks on the desired individual's Life Ledger 24, and has access to all the individual's vital data stored in the database 25. The caregiver then selects any of the web pages for which he or she has access and inputs/deletes/or edits as the case may be, vital information data pertaining to the individual in the manner described above.

This provides the advantages that the caregiver can efficiently provide high quality care to a plurality of individuals, without using incorrect or old vital information. Thus the present invention provides, in an easy to use tool (web site), a way for a caregiver to instantly have access to all the vital information pertaining to an individual that is stored in the Life Ledger 24 database 25. This solves of the problems associated with the prior art, such as lost and forgotten medical histories, confusion on who to contact in an emergency, confusion with respect to post death issues and insurance issues, confusion as to sketchy medical histories, confusion with respect to financial issues as these can be quite complex, and so forth. The system is secure and accurate and is a time saving and potentially life saving tool for use in the care of an individual.

Thus the tremendous advantages of utilizing such a system 10 in providing effective care are readily apparent. The system 10 and method of the present invention interweaves the many years of knowledge and experience gained in professional service by caregivers. A higher quality level of care for the individuals under the care of the caregiver is thus provided. The process causes caregivers to be more effective providers of care, thereby reducing the time and cost required to gain the knowledge through alternate, outmoded methods of care giving. The non-professional family caregiver's effectiveness and efficiency is dramatically increased as well, and this ultimately reduces the dependence on the healthcare system and other governmental agencies. Further, this process indirectly benefits the caregiver by reducing the negative impact that the caregiver status has on their professional, marital and social life. The non-professional caregiver ultimately has more time for herself or himself while simultaneous ensuring the individual under care is not being neglected or forgotten.

It is to be understood that various changes in the details, parts, steps, and arrangements, which have been described herein, may be made by those skilled in the art within the principles and scope of the present invention. While embodiments of the present invention have been described in detail, that has been done for the purposes of illustration, not limitation.

What is claimed:

1. A method for assisting caregivers in caring for an individual comprising the acts of:
providing a server computer comprising a central processing unit,
executing a computer software program on a server computer, the server computer in communication with a computer network;
inputting data into the server computer by way of the computer network;
processing the input data by the central processing unit the act of which comprises sending the input data to a database, the input data comprising the individual's vital information data;
requesting over the computer network vital information data; and
generating an output from the server computer in response to the request for vital information data and outputting the output to the computer network.

2. The method of claim 1 further comprising the act of providing a life ledger for comprising at least one web page and comprising a database, the at least one web page for allowing the caregiver interact with the database.

3. The method of claim 2 wherein the life ledger further comprises a plurality of web pages for the entry of the following vital information data: emergency information data, general information data, support people data, medical data, health status data, insurance data, financial data, budget planner data, legal data, funeral planning data, document data, and physician data.

4. The method of claim 1 comprising the acts of embodying the server computer as a web application server computer and providing the web application server with login security encryption and further providing the web application server computer with a merchant account for billing the caregiver for each life ledger purchase by the caregiver.

5. The method of claim 1 further comprising the step of providing the server computer with computer executable instructions for causing at least one web page to be generated and displayed on a display device, the at least one web page for displaying vital information data.

6. The method of claim 5 wherein the communication network in communication with the server computer is the internet.

7. The method of claim 1 further comprising the acts of:
providing a plurality of computer executable instruction; and
causing the server computer to execute the plurality of computer executable instructions and generate a life buoy feature, the life buoy feature for providing relevant information in caring for the individual.

8. The method of claim 7 wherein the life buoy feature is electronically linked to an electronic help finder and the life buoy feature is electronically linked to a plurality of articles stored in an article database.

9. A method for assisting caregivers in caring for an individual comprising the acts of:
providing a client computer comprising a graphical user interface, the client computer in communication with a computer network;
inputting vital information data, the vital information data pertaining to the individual, into the client computer by way of the graphical user interface, and transmitting the vital information data over the computer network;
requesting the vital information data from the computer network;
receiving the vital information data from the computer network;
accessing the received vital information data by way of the client computer in communication with the computer network; and
viewing the vital information data on the client computer graphical user interface.

10. The method of claim 9 wherein the act of inputting vital information data comprises the act of inputting the following data: general information data, emergency data, medical data, health status data, financial information data, budget information data, funeral planning data, and legal data, document data, and physician data.

11. The method of claim 9 further comprising the step of providing an editing feature so that the vital information data can be edited from the client computer graphical user interface over the computer network regardless of where the client computer is located.

12. The method of claim 9 wherein accessing the computer network requires an authorized password and payment of a fee to a merchant account in communication with the client computer over the computer network.

13. A method for assisting caregivers in caring for an individual comprising the acts of:
providing a server computer having a central processing unit in communication with a computer network;
providing a client computer in communication with the computer network so that the server computer and the client computer are in communication with one another by way of the computer network;
inputting vital information data pertaining to the individual into the client computer;
transmitting the input vital information data pertaining to the individual to the server computer's central processing unit, the central processing unit for causing the input vital information data to be processed, stored, and organized into a life ledger, the life ledger comprising at least one database;
requesting vital information data from the at least one database by the caregiver;
supplying the requested vital information data by the server computer; and
generating an output in response to the caregiver request and outputting the output the caregiver.

14. The method according to claim 13 further comprising the acts of:
providing the life ledger with a database for storing and organizing the vital information data the database comprising a plurality of data tables.

15. The method according to claim 14 comprising the acts of:
providing the life ledger with a plurality of web pages, a separate web page for the entry of vital information data pertaining to each of the following: general information data, an emergency information data, a support people data, medical data, health status data, insurance data, financial data, budgeting data, legal data, funeral planning data, document data, and physician data.

16. The method according to claim 15 comprising the acts of:
providing the life ledger with the plurality of web pages and providing the client computer with a graphical user interface for displaying and interacting with the plurality of web pages, the plurality of web pages comprise the following: a general information web page, an emergency web page, a support people data, a medical web page, a health status web page, an insurance web page, a financial web page, a budgeting web page, a legal web page, a funeral planning web page, a document web page, and a physician web page.

17. The method according to claim 13 further comprising the steps of:
providing a computer software program comprising computer readable instructions;
executing the computer software program on the server computer's central processing unit;
causing the server computer to generate a plurality of web pages when executing the computer readable instructions;
providing a client computer with a graphical user interface for viewing and interacting with the plurality of web pages;
providing a database for storing and organizing the vital information data;
entering the vital information data into data input boxes in each of the web pages caused to be generated by the computer software program being executed on the server computer; and
storing the vital information data in the database.

18. The method according to claim 17 further comprising the acts of:
providing an electronic life buoy, the electronic life buoy caused to be generated when the computer software program is executed on the server computer;
accessing the electronic life buoy; and
providing the electronic life buoy with an electronic link to articles.

19. The method of claim 18 further comprising the acts of:
providing the electronic life buoy with an electronic link to an electronic help finder;
providing the electronic help finder with data input boxes defining the parameters of a database search;
providing a data input box for the entry of a zip code and providing a data input box for a topic to be searched;
entering search parameters in the data input boxes, the search parameters comprising the zip code and topics to be searched; and
generating a search result by having the central processing unit search the database and locating all care providers in the database that match the parameters, and displaying the search result on an output device.

20. A system for assisting a caregiver in providing care for an individual comprising:
a server computer comprising a central processing unit in communication with a computer network;
a client computer in communication with the computer network so that the server computer and the client computer are in communication with one another by way of the computer network;
computer executable instructions for being executed on the central processing unit,
a life ledger comprising a database, the database in communication with the server computer and for storing vital information data therein, the life ledger comprising a plurality of web pages for displaying the vital information data stored in the database.
the client computer comprising a graphical user interface display for displaying the plurality of web pages of the life ledger.

21. The system according to claim 20 wherein the life ledger further comprises an edit feature so that the vital information in the life ledger may be edited from the client computer over the computer network.

22. The system according to claim 21 wherein the life ledger further comprises web pages for the input of vital information data pertaining to each of the following types of data: general information data, emergency information data, support people data, medical data, health status data, insurance data, financial data, budgeting data, legal data, funeral planning data, document data, and physician data.

23. The system of claim 22 wherein the server computer comprises executes computer readable instructions and generates the life ledger, and further comprises a merchant account to keep track of and bill the caregiver for each for each life ledger purchased by the caregiver, and the server computer further provides for encryption for the web site.

24. The system according to claim 23 further comprising an electronic life buoy, the electronic life buoy comprises electronic links to articles of interest to the caregiver.

25. The system according to claim 22 wherein a web page for each of the following is caused to be generated by the computer executable program being executed on the server computer: a general web page, an emergency web page, a support people web page, a medical web page, a health status web page, an insurance web page, a financial web page, a budgeting web page, a legal web page, a funeral planning web page, a document web page, and a physician web page.

26. The system according to claim 25 wherein the each of the web pages has a graphical user interface for the editing of vital information data input into the web page.

27. A computer program product for use with a computer, the computer program product comprising:
a computer usable medium comprising computer readable program codes embodied in the computer usable medium, the computer readable program codes for causing the computer to:
define fields for the input of vital information data pertaining to an individual under a caregiver's care;
generate a plurality of graphical user interface screen displays when the computer program product is executed on the computer; and
create data structures for storing and organizing the vital information data inputted when the computer program product is executed on the computer,
create a merchant account,
create a life buoy,
create encryption for security.

28. The computer program product of claim 27 wherein the computer program product is embodied a medium selected from the group consisting of: a CD-ROM, a magnetic tape, an optical disk and a carrier wave transmission.

29. The computer program product of claim 28 wherein the input fields are defined for a life ledger 24 that further defines input fields for the following: general data, emergency data, support people data, medical data, health status data, insurance data, financial data, budgeting data, legal data, funeral planning data, important document data, and physician data.

30. The computer program product of claim 29 wherein the computer program product is for causing the input data to be entered by way of a graphical user interface.

31. The computer program product of claim 27 wherein the computer is a web application server computer that is in communication with a computer network and in communication with a client computer.

32. An article of manufacture comprising:
a computer usable medium comprising computer readable program codes embodied in the computer usable medium, the computer readable program codes for causing the computer to:
define fields for the input of vital information data pertaining an individual under a caregiver's care when the computer readable codes are executed on the computer;
generate a plurality of graphical user interface screen displays when the computer program product is executed on the computer; and
create a database comprising data structures for storing and organizing the vital information inputted when the computer program product is executed on the computer.

33. A method for a caregiver to provide care to an individual comprising the acts of:
providing a web site that comprises a server computer and a life ledger, the life ledger comprises a database for storing the individual's vital information data,
receiving from a caregiver's computer a request for vital information data selected from the individual's life ledger,
transmitting from the server computer to the caregiver's computer by way of a carrier wave signal data comprising the vital information requested from the individual's life ledger, and
receiving and displaying the vital information data on the caregiver's computer screen.

34. The method according to claim 33 further comprising the act of providing the web site with a plurality of web pages for the life ledger, each web page for inputting and displaying vital information data pertaining to the individual.

35. The method according to claim 34 wherein the plurality of web pages comprise web pages for inputting, editing, and displaying the following data about the individual: general data, emergency data, support people data, medical data, health status data, insurance data, financial data, budgeting data, legal data, funeral planning data, important document data, and physician data.

36. The method according to claim 35 further comprising providing the web site with a life buoy feature for providing help to the caregiver in response to a request to the caregiver for help, the life buoy having the appearance of a life buoy on the caregiver's computer screen.

37. The method according to claim 33 further comprising the step of the caregiver requesting the purchase of an electronic life ledger by transmitting to the server computer the request by carrier waves, and the server computer comprising a merchant account and in response to the request to purchase a life ledger automatically bills the caregiver for the purchase of the life ledger.

38. A method for a caregiver to care for an individual comprising the steps of:
providing a client computer;
providing a web application server computer in communication with the client computer over a computer network;
providing a new computer generated life ledger comprising no vital information data inputs to the caregiver;
selling the new computer generated life ledger for a fee to the caregiver over the computer network;
providing the web application server with a merchant account; and
using the merchant account for billing the caregiver for the life ledger 24.

39. The method of claim 38 further comprising the steps of selling the caregiver additional new computer life ledgers and using the web application server's merchant account for sending billing statements to the caregiver over the computer network for each of the additional life ledgers sold to the caregiver.

40. The method according to claim 39 further comprising the steps of:
providing the new computer generated life ledger with a database for storing vital information data wherein the vital information data that can be stored therein comprises:
general data, emergency data, support people data, medical data, health status data, insurance data, financial data, budgeting data, legal data, funeral planning data, important document data, and physician data.
